(19) United States
(12) Patent Application Publication
(10) Pub. No.: US 2026/0017600 A1
(43) Pub. Date: Jan. 15, 2026

(54) Cargo Tracking Device, System, and Method

(71) Applicant: Sojo Industries, Inc., Bristol, PA (US)

(72) Inventors: Josh Schwartz-Dodek, Philadelphia, PA (US); Barak Bar-Cohen, Princeton, NJ (US)

(21) Appl. No.: 19/266,455

(22) Filed: Jul. 11, 2025

Related U.S. Application Data
(60) Provisional application No. 63/670,196, filed on Jul. 12, 2024.

(51) Int. Cl. G06Q 10/0833

(52) U.S. Cl. CPC G06Q 10/0833

(57) ABSTRACT

Systems, apparatuses, and methods are described for tracking palletized cargo using a pressure-sensitive tracking device. The tracking device may be situated at a cargo transportation surface. The cargo transportation surface may be a corrugated pad configured to be placed between a pallet and cargo supported by the pallet. The tracking device may reside within the flutes of the corrugated pad. The tracking device may detect loading and unloading events and, in response, transmit a message with tracking information. The tracking information may include the geographic location of the tracking device at a current time.

### CROSS-REFERENCE TO RELATED APPLICATIONS

This application is a claims the benefit of U.S. Provisional Patent Application No. 63/670,196 titled “Cargo Tracking Device, System, and Method” filed on Jul. 12, 2024, which is incorporated by reference in its entirety herein.

The following applications also are incorporated by reference in their entirety, and each is hereby expressly made a part of this specification: U.S. Provisional Patent Application No. 63/590,911 titled “Tracking Seal Device, System and Method” and filed on Oct. 17, 2023; U.S. Provisional Patent Application No. 63/564,945 titled “Tracking Device, System and Method” and filed on Mar. 13, 2024; and U.S. patent application Ser. No. 18/915,817 titled “Sealing Device, System, and Methods” and filed on Oct. 15, 2024.

### FIELD

The present disclosure generally relates to sensors for tracking, more particularly relates to sensors for tracking cargo shipments, and specifically relates to sensors for tracking shipments of palletized cargo.

### BACKGROUND

Track and trace devices are used in logistics, supply chain management, and the shipping industry to assure that cargo safely reaches its destination. This provides several key benefits, including enhanced security, improved accountability, reduced risk of loss, faster response to issues, quality control, regulatory compliance, data for process optimization, improved customer service, reduced insurance costs, real-time decision-making, theft deterrence, geographical awareness, sustainability and asset protection.

More specifically, real-time monitoring allows for immediate detection of tampering or unauthorized access to the cargo. This helps to prevent theft, damage, or tampering with valuable goods during transit. With real-time tracking, both the sending and receiving entity can hold each other accountable for the cargo's condition and security. Knowing that cargo is being monitored in real-time also deters potential thieves or dishonest employees, reducing the risk of cargo loss and resulting in cost savings for businesses. Real-time data allows for swift responses to incidents such as tampering, accidents, or delays, mitigating potential damage and minimize disruptions to the supply chain. For cargo that requires specific environmental conditions, real-time monitoring ensures these conditions are maintained, critical for products such as pharmaceuticals, perishable goods, and high-value electronics.

The data collected during transit can further be analyzed to identify patterns and opportunities for improvement in the supply chain. This can lead to more efficient operations, reduced costs, and improved customer satisfaction, while providing logistics and supply chain managers data to make informed, real-time decisions. This includes re-routing shipments in case of delays or security threats. Real-time tracking provides a clear understanding of where the cargo is at any given time, which can be particularly useful in large-scale global supply chains. Efficient supply chain management helps reduce fuel consumption, emissions, and overall environmental impact by minimizing unnecessary stops and delays.

As conventional track and trace devices currently available may be expensive, complex, bulky, and/or require cumbersome system requirements, the industry would benefit from a simplified low-cost track and trace device that is single use and disposable. Low-cost, single-use, and disposable track and trace devices would be particularly useful and advantageous for shipments of palletized loads. To facilitate cargo shipments, shippers often palletize the cargo by loading it onto a pallet and secure it to the pallet by wrapping or other means. Upon successful delivery, pallets are often discarded and not recovered by the original shipper. The shipping industry, therefore, would benefit from a low-cost track and trace device that accounts for the disposable and single-use nature of pallets used to ship palletized cargo. The disclosures provided herein fit this need.

### BRIEF DESCRIPTION OF THE DRAWINGS

The present disclosure is illustrated by way of example and not limited in the accompanying figures in which like reference numerals indicate similar elements and in which:

FIG. 1 depicts an example of a cargo tracking device positioned on a corrugated layer of a pad in accordance with aspects of the present disclosure.

FIG. 2 depicts a block diagram of a palletized load with a cargo tracking device in accordance with aspects of the present disclosure.

FIGS. 3A-C depict block diagrams of examples of cargo tracking devices in accordance with aspects of the present disclosure.

FIGS. 4A-C depict cross-sectional diagrams of examples of cargo tracking devices positioned on a corrugated layer in accordance with aspects of the present disclosure.

FIGS. 5A-C depict cross-sectional diagrams of additional examples of cargo tracking devices positioned on a corrugated layer in accordance with aspects of the present disclosure.

FIGS. 6A-B depict cross-sectional diagrams of additional examples of cargo tracking devices positioned on a corrugated layer in accordance with aspects of the present disclosure.

FIGS. 7A-B depict cross-sectional diagrams of additional examples of cargo tracking devices positioned on a corrugated layer in accordance with aspects of the present disclosure.

FIGS. 8A-L depict block diagrams of example cargo tracking devices positioned on a corrugated layer in accordance with aspects of the present disclosure.

FIGS. 9A-B depict an example of a cargo tracking device positioned on a corrugated layer of a pad in accordance with aspects of the present disclosure.

FIGS. 10A-B depict an example of a cargo tracking device positioned on a corrugated layer of a pad in accordance with aspects of the present disclosure.

FIG. 11 depicts an example of a cargo tracking device positioned on a corrugated layer of a pad in accordance with aspects of the present disclosure.

FIG. 12 depicts an example of a cargo tracking device positioned on a corrugated layer of a pad in accordance with aspects of the present disclosure.

FIG. 13 depicts an example of a cargo tracking device positioned on a corrugated layer of a pad in accordance with aspects of the present disclosure.

FIG. 14 depicts an example of a cargo tracking device positioned on a corrugated layer of a pad in accordance with aspects of the present disclosure.

FIG. 15 depicts an example of a cargo tracking device positioned on a corrugated layer of a pad in accordance with aspects of the present disclosure.

FIG. 16A depicts an example of a cargo tracking device positioned on a corrugated layer of a pad in accordance with aspects of the present disclosure.

FIG. 16B depicts a cross-sectional view of the example cargo tracking device of FIG. 16A.

FIG. 17 depicts an example of a cargo tracking device positioned on a corrugated layer of a pad in accordance with aspects of the present disclosure.

FIG. 18A depicts an example sequence flow for tracking cargo shipments.

FIG. 18B depicts a flow chart of example method steps for tracking palletized cargo using pad having a cargo tracking device.

FIG. 19 depicts an example block diagram of a cargo tracking system in accordance with aspects of the present disclosure.

FIG. 20 depicts a block diagram of an example of a computing device that may be used in implementing one or more aspects described herein.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure. Further, headings within this disclosure should not be considered as limiting aspects of the disclosure. Those skilled in the art with the benefit of this disclosure will appreciate that the example embodiments are not limited to the example headings.

Aspects of the disclosure generally relate to sensors for tracking, more particularly relate to sensors for tracking cargo shipments, and specifically relate to sensors for tracking shipments of palletized cargo. Aspects of example embodiments and implementations are discussed in greater detail throughout this disclosure, including the accompanying drawings.

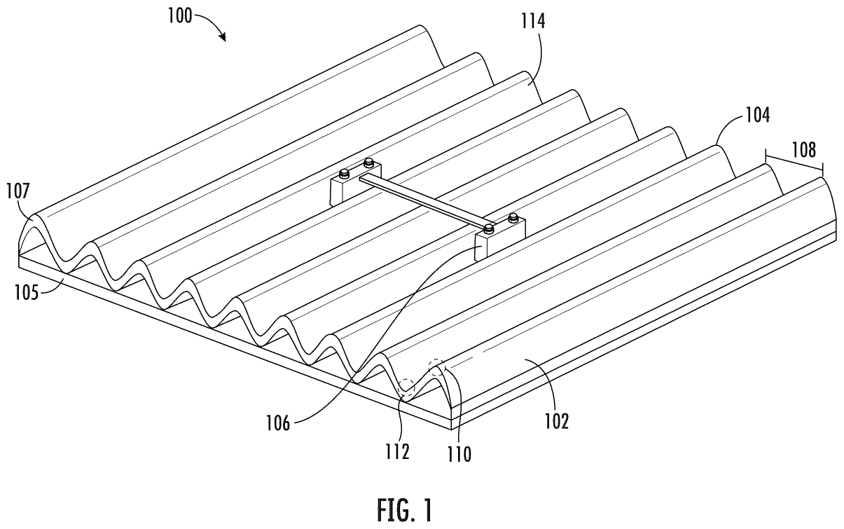

To introduce the concepts directed to the cargo tracking device, system, and method disclosed herein, reference is first made to FIG. 1, which depicts an example of a cargo tracking device 100 in accordance with aspects of the present disclosure. A cargo tracking device 100, such as those described herein, may be used to track the geographical location of palletized cargo during shipment. The cargo tracking device 100, therefore, includes electronics configured to detect the geographical location of the palletized load and transmit a signal indicating that geographical location with a corresponding date and time. This signal is referred to herein, for convenience, as a geolocation signal. In this way, a recipient of the geolocation signal will be informed of where the pallet is located and when. The geolocation signal thus acts as a digital “ping” when the cargo is unloaded from a pallet. As described herein, a cargo tracking device 100 may be configured to transmit the geolocation signal at least based on detecting unloading of the cargo from the pallet. The cargo tracking device thus includes a geolocation module to obtain its geographical location. In some examples, a cargo tracking device may be configured to transmit respective geolocation signals based on detecting both loading of the cargo onto the pallet (e.g., at the shipper's location) and unloading of the cargo from the pallet (e.g., at the receiver's location). To detect loading and/or unloading of the cargo, the cargo tracking device includes one or more force (pressure, load) sensors 104. As described herein, the force sensors 104 may be configured to activate upon detecting a threshold amount of force (e.g., due to the weight of the cargo being loaded onto the pallet) and to emit a signal when that force is released (e.g., due to the cargo being unloaded from the pallet). The cargo tracking device thus also includes microcontroller configured to receive the signal from the force sensor and, in response, transmit the geolocation signal. In some instances, the microcontroller may include one or more processor communicatively coupled to one or more force sensors 104. The geolocation signal may be configured for transmission via one or more wireless networks (e.g., cellular networks, wireless Ethernet, Bluetooth, etc.). The cargo tracking device thus also include one or more communication modules configured for wireless transmission via a suitable network.

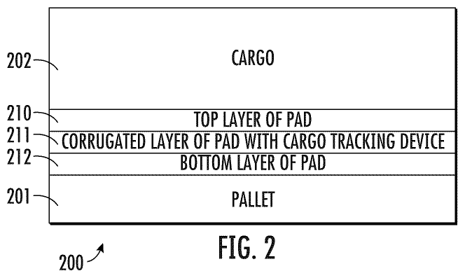

A cargo tracking device may be used to track an individual pallet, and respective cargo tracking devices may be used to respectively track multiple pallets. A pad 106 may be included with a palletized load between the pallet and the cargo loaded onto the pallet. In this regard, the pad 106 may be described as being “sandwiched” between an upper side (e.g., upper surface) of the pallet and the lower surface of the cargo supported on the pallet. This arrangement of the pallet 201, pad layers (top layer 210, corrugated layer 211, bottom layer 212), and cargo 202 is depicted by way of example in the block diagram of FIG. 2. As illustrated in FIG. 2, the pad layers may include a bottom layer 212, a corrugated layer 211 with the cargo tracking device, and a top layer 210. In this regard, the cargo tracking device may be described as being integrated into the pad or “sandwiched” between the pad layers (e.g., the top layer 210 and the bottom layer 212). The pad layers may be assembled prior to placement between the pallet 201 and cargo 202. The pad layers may have the same or different construction (e.g., materials, dimensions, shape, texture, etc.). The pad 106 may be, as shown in FIG. 1 for example, a corrugated pad 107 having a series of fluted channels 108. The cargo tracking device 100 may be configured for insertion between the flutes 108 of the corrugated pad 107. The dimensions of a cargo tracking device 100, therefore, may depend on the dimensions of the flutes 108 of the corrugated pad 107 it will be inserted into. The cargo tracking device 100 may be secured within the corrugated pad 107 by a top layer (not shown in FIG. 1) applied and joined to the corrugated layer. Additional and alternative examples will be appreciated with the benefit of this disclosure. For example, in some implementations, the pad may be a single layer of one or more materials (e.g., a uniform material or a combination of materials) with the components of the cargo tracking device (e.g., processor, force sensor, communication module, and other electronics) integrated or incorporated onto or into the singular layer. The materials may possess properties (e.g., compressibility, flexibility, resilience, thickness, etc.) that enable the load cells of the force sensors to function.

As seen in FIG. 1, for example, the cargo tracking device 100 includes at least one housing that rests in the valley 112 of one of the flutes 108 of the corrugated pad 107 between the peaks (crests) 110 of adjacent flutes. As described herein, a cargo tracking device may include a single housing 102 that houses all of the electronics used for detecting pallet loading and/or unloading, determining its geographical location, and transmitting the geolocation signal. A cargo tracking device alternatively may include multiple housings. The cargo tracking device 100 depicted in FIG. 1, for example, includes two housings 102 each with multiple force sensors 104 (two per housing in this example). The cargo tracking device 100 is configured to position the force sensors 104 near the peaks 110 of the fluted layers 108 such that the force sensors 104 are exposed to the weight of the cargo and can be activated based on the cargo being loaded onto the pallet. The cargo tracking device, therefore, may have a height that positions the force sensors at, slightly above, or slightly below the peaks 110 of the flutes 108 of the corrugated layer 107. The height of a housing 102 of the cargo tracking device 100, therefore, may depend on the height of the corrugated layer 107. The width of the housing 102 of the cargo tracking device also may depend on the width of the flutes 108 of the corrugated layer 107. The width of the housing 102 may impact the susceptibility of the cargo tracking device 100 to shifting back and forth while resting in the flute 108 of the corrugated layer 107. For example, a relatively wider housing 102 may have relatively fewer degrees of freedom to shift back and forth in the flute 108 while a relatively narrower housing 102 may have relatively more degrees of freedom to shift back and forth. As described herein, a cargo tracking device 100 may include one or more mechanical components (e.g., connector 114) to stabilize the housing 102 while resting in the flute 108 of the corrugated layer 107 and facilitate orienting the force sensors 104 in a substantially vertical orientation to detect the weight of the cargo loaded and unloaded onto the pad 106. The example cargo tracking device 110 depicted in FIG. 1, for example, includes a connector 114 between its two housings 102. As described herein, the connector may be electromechanical in nature (e.g., to provide both mechanical stability for and electronic communication between the housings) or may be purely mechanical in nature (e.g., providing only mechanical stability). The pad 106 may be applied to the pallet manually or using an automated means.

The example corrugated pad shown in FIG. 1 includes a flat bottom layer 105, a corrugated (fluted) middle layer 107, and a flat top layer (not shown in FIG. 1). The bottom layer 105 and top layer of the corrugated pad may be joined to the middle layer via adhesives or other means. The corrugated pad 106 depicted in FIG. 1 may be described as a single-wall, double-face (3-ply) pad. The corrugated layer 107 may include a series of fluted channels (flutes) 108 defined by alternating peaks 110 and valleys 112. The fluted channels 108 of the corrugated layer 107 may exhibit a relatively smoother transition between the peaks 110 and valleys 112 of its fluted channels 108 thereby providing relatively more rounded contours across the corrugated layer 107 and a wave (or wave-like) cross section as depicted in FIG. 1 for example. The fluted channels 108 of the corrugated layer 107 alternately may exhibit a relatively sharper transition between the peaks 110 and valleys 112 of its fluted channels 108 thereby providing relatively more pointed contours across the corrugated later 107 and a sawtooth (or sawtooth-like) cross section. The corrugated layer 107 may exhibit various constructions, shapes, contours, dimensions, and thicknesses. For example, doubled-wall pads (5-ply) or triple-walled pads (7-ply) may be used. As another example, the thickness of the pads (e.g. bottom layer 105 and/or corrugated layer 107) may depend on the quantity of walls the pad 106 includes and the height of the flutes 108. Flute heights may range between 1/32 inch (in.) to ¼ in. as measured, for example, from the wall adjacent to a flute valley to the wall adjacent to the flute peak. Flutes may be characterized based on their height, e.g., A flutes (about ¼ in.), B flutes (about ⅛ in.), C flutes (about 11/64 in.), E flutes (about 1/16 in.), and F flutes (about 1/32 in.). Double-wall pads and triple-wall pads may include fluted layers (e.g., 107) that each have a different height (e.g., a double wall pad with an A flute layer adjacent to an E flute layer, a triple wall pad with an A flute layer adjacent to a B flute layer followed by another A flute layer). The pad 106 (e.g., corrugated pad) may be sized to fit within the dimensions of a pallet. The pad 106, therefore, may have a length and width no greater than the length and width of the pallet. In other words, the area of the pad 106 may be no greater than the area of the pallet. In some examples, the pad 106 may be slightly larger than the pallet (e.g., slightly longer and/or wider than the pallet). The pad 106 may exhibit the same shape of the pallet (e.g., square, rectangular) or exhibit a different shape than the pallet (e.g., circular, oval, triangular). The pallet may be a standard consumer packaged goods (CPG) pallet or another type of pallet. The pallet may have a length and width of about 48 inches (in.) by about 40 inches. The pallet may have alternative lengths and/or widths.

The footprint of a cargo tracking device 100 may depend, at least in part, on the size of the pad 106 applied to the pallet. For a 48 in. by 40 in. pad, the footprint of the cargo tracking device 100 may be up to about 48 in. by about 40 in. in some examples. In other examples, the footprint of a cargo tracking device 100 may be larger or smaller. In general, the footprint of a cargo tracking device 100 may be, for example, between about ½ in. by about ½ in. to about 48 in. by about 40 in. The thickness of a cargo tracking device 100 also may depend on the thickness of the pad 106 (e.g., the height of the flutes, the thickness of the flute layer). In some examples, the thickness of the cargo tracking device 100 may be up to ¼ in. (6.35 mm) thick. In other examples, the thickness of the cargo tracking device 100 may be thinner. In general, the thickness of a cargo tracking device 100 may be, for example, between about ⅛ in. to about ½ in. As described herein, a cargo tracking device 100 may include one or more housings 102. The dimensions of the housing 102 may depend, at least in part, on the dimensions of the electronics housed within the housing 102. In some examples, a single housing (e.g., 102) may house all of the electronics of a cargo tracking device. In other examples, the electronics of the cargo tracking device 100 may be distributed across multiple housings. In some examples, the housing of a cargo tracking device may be about ½ in. long by about ½ in. wide by ⅛ in. thick. In other examples, the housing may be longer, wider, or thicker (e.g., for purposes of stability, larger distances between the force sensors, etc.). As also described herein, a cargo tracking device may include one or more mechanical stabilizers 114 (e.g., one or more ribbons, webbing, etc.). In some examples, the mechanical stabilizers 114 may include one or more of the electronic components of a cargo tracking device. In some examples, the dimensions of an electromechanical or mechanical stabilizer of a cargo tracking device may be about 4 in. long by about 4 in. wide by about ⅛ in. thick. In other examples, the stabilizers may be longer, wider, or thicker. In some examples, the weight of a cargo tracking device 100 may be less than 2 pounds. In some examples, the weight of a cargo tracking device 100 may be less than ½ pound.

To facilitate its disposability, the pad 106 may be constructed using a minimum of components. Those components may include, for example, the components used to provide the functionality that enables the geographic location of the pallet to be determined and then signaled based on the cargo being unloaded from the pallet. In other words, a cargo tracking device 100 may exclude extra peripherals and/or hardware components that are not used to detect cargo loading and/or unloading, generation of the geolocation signal, and transmission of the geolocation signal. In some examples, those components may include at least one force sensor 104 configured to detect loading and unloading of the cargo, a microcontroller configured to trigger transmission of a geolocation signal, at least one communication interface configured to transmit the geolocation signal, a power source (e.g., a battery) configured to power these components, and a housing 102 that houses the components. In some examples, the power available may be limited to the power used for monitoring the status of the force sensor after activation and transmitting the geolocation signal. By limiting the available power, relatively smaller power sources may be used thereby allowing the cargo tracking device to satisfy the relatively smaller form factor dictated, for example, by the dimensions of the corrugated pad 107. The type power supply (e.g., alkaline batteries) also may be selected for disposability. Similarly, by minimizing the components of the cargo tracking device, the overall size of the cargo tracking device may be minimized to also satisfy the relatively smaller form factor of a corrugated pad. Minimizing the components of the cargo tracking device may also minimize the cost of the cargo tracking device 100 to facilitate its single, one-time use.

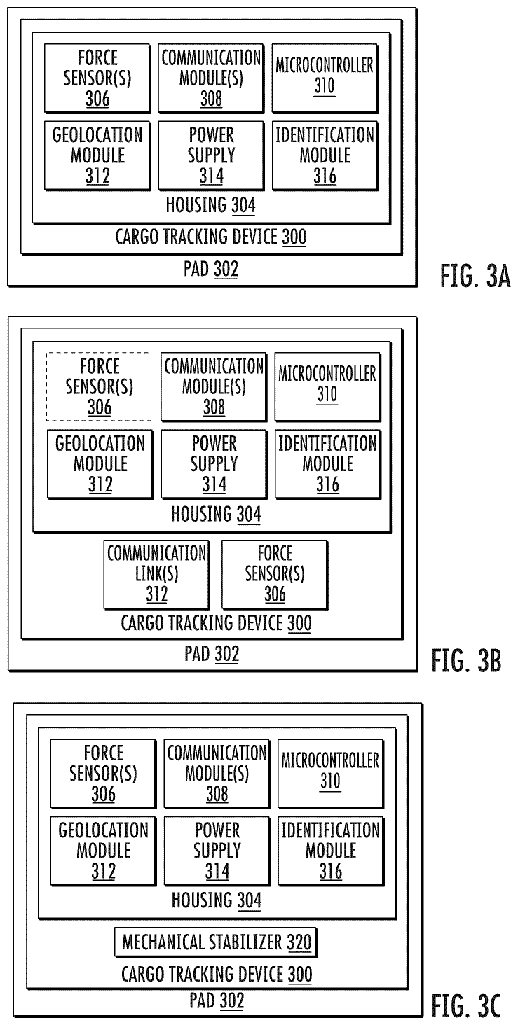

Referring now to FIGS. 3A-C, block diagrams of example cargo tracking devices 300 are shown. The example cargo tracking devices 300 depicted in FIGS. 3A-C each include a housing 304. The housing 304, in each of these three example cargo tracking devices 300, includes an identification module 316, a microcontroller 310, one or more communication modules 308, a power supply 314, and a geolocation module 312. The respective housings of the example cargo tracking devices depicted in FIGS. 3A and 3C also include one or more force sensors 306. The force sensors 306 may be fully embedded in, partially embedded in, or attached to the housing 304 of the cargo tracking device 300. The example cargo tracking device 300 depicted in FIG. 3B includes one or more force sensors 306 that are not housed within the housing 304 but are instead connected to the microcontroller 310 within the housing 304 via one or more communication links 318. The example cargo tracking device depicted in FIG. 3B also may include one or more force sensors 306 housed within the housing 304 as indicated by the dashed lines in FIG. 3B. The force sensors not housed within the housing 304 of the cargo tracking device 300 depicted in FIG. 3B may be referred to, for convenience, as external force sensors, tethered force sensors, or remote force sensors. Force sensors 306 housed within or attached the housing of a cargo tracking device 300 may be referred to, for convenience, as internal force sensors or local force sensors. In some examples, the communication links 318 may provide both electronic communication between the external force sensors and the microcontroller 310 as well as mechanical stability for the housing 304 of the cargo tracking device while it rests within a flute of a corrugated layer of the pad 302. The communication links 318, therefore, may exhibit a sufficient rigidity to stabilize the housing 304 of the cargo tracking device 300 in a substantially vertical orientation as described herein. The communication links 318, while sufficiently rigid to stabilize the housing 304, nevertheless may exhibit at least some flexibility. The example cargo tracking device depicted in FIG. 3C includes internal force sensors 306 and a mechanical stabilizer 320. The mechanical stabilizer 320 likewise may exhibit a sufficient rigidity to stabilize the housing 304 of the cargo tracking device in a substantially vertical orientation.

In other examples, a cargo tracking device may include multiple housings (e.g., housing 102 depicted in FIG. 1, or housing 304 depicted in FIGS. 3A-3C). In some examples, each housing may include one or more force sensors. In some examples, one housing (e.g., an electronics housing) may not include any force sensors and instead include only the logic, location, identification, and power components (e.g., the microcontroller, communication module(s), identification module, and power supply) while one or more other housings include one or more force sensors. In some examples, the logic, location, identification, and power components may be distributed across separate housings that are interconnected with each other. In some examples, each of the multiple housings may include one or more stabilizers as described herein (e.g., one or more electromechanical stabilizers that facilitate electronic communication between the housings and impart mechanical stability, one or more purely mechanical stabilizers that only impart mechanical stability, a combination of electromechanical stabilizers and mechanical stabilizers). In some examples, one or more external force sensors may not be included in or attached to any housing and instead may be connected to a housing (e.g., an electronics housing) via respective communication links as described herein.

The identification module (e.g., identification module 316 depicted in FIGS. 3A-3C) may be configured to provide a unique identifier (UID) of the cargo tracking device. The identification module may be or otherwise include, for example, a radio frequency identification (RFID) component (e.g., an RFID tag) that provides the UID of the cargo tracking device. The UID cargo tracking device may be read or otherwise obtained by reading or scanning the RFID component (e.g., using a suitable RFID reader/scanner/receiver). Alternative technologies may be used to provide the UID of the cargo tracking device.

The force sensors (e.g., force sensor 104 depicted in FIG. 1 or force sensor(s) 306 depicted in FIGS. 3A-3C) may be configured to detect cargo being loaded on and unloaded from the pallet. In some examples, the force sensors may be configured to output a signal corresponding (e.g., analogous) to the force received. In some examples, the force sensors may be configured to output a signal only based on the received force satisfying (e.g., meeting or exceeding) a force threshold. The force threshold may be fixed at the force sensor or may be a configurable parameter of the force sensor (e.g., in firmware). The force threshold may be selected or configured to be greater than the anticipated forces on the cargo tracking device when manufacturing the pad. As described herein, the pad may be manufactured by inserting the cargo tracking device in the corrugated layer of the pad and then joining the upper layer to the corrugated layer. For example, the pad may be manufactured via a lamination process that joins the layers of the corrugated pad together. The force threshold, therefore, may be selected or configured to be greater than the forces experienced during this lamination process (e.g., in the range of 1-100 pounds of force or larger than 100 pounds of force). Example force thresholds may include relatively smaller force thresholds (e.g., in the range of about 1-10 pounds of force or in the range of about 1-5 pounds of force or in the range of about 1-2 pounds of force or in the range of about 5-10 pounds of force or in the range of about 8-10 pounds of force) or relatively larger force thresholds that may correspond to relatively lighter cargo (e.g., in the range of about 50-100 pounds of force or in the range of about 50-75 pounds of force or in the range of about 50-60 pounds of force or in the range of about 75-100 pounds of force or in the range of about 90-100 pounds of force). In some examples, a force threshold may be configured based on an expected weight of the cargo (e.g., equal to the expected weight of the cargo or some percentage of the weight of the cargo such as in the range of about 5-95% of the expected weight of the cargo).

As also described herein, a cargo tracking device may include one or more force sensors. Each force sensor may be configured to provide a signal to the microcontroller. The signal provided to the microcontroller may indicate a positive or negative amount of force detected or otherwise measured at the force sensor. A signal indicating detection of a positive or negative force (e.g., yes/no, true/false) or indicating a measurement of a positive or negative amount of force may be quantized with any desired bit resolution (e.g., a 2-bit resolution for indicating force detection (e.g., 1 when a force is detected and 0 when a force is not detected) and a greater than 2-bit resolution (e.g., 3-bit, 4-bit, 8-bit, 16-bit, etc.) for indicating force measurement). A force sensor may indicate a positive force detection or measurement when, for example, cargo is loaded onto a pallet. A force sensor may indicate a negative force detection or measurement when, for example, cargo is unloaded from the pallet. In some examples, a force sensor may provide a signal only when a negative amount of force is detected or measured (e.g., based on cargo being unloaded from the pallet). In these examples, the force sensor may function as a “dead man's switch” whereby the force sensor is prevented from providing a signal based on a positive force being detected or measured at the force sensor (e.g., loading of the cargo onto the pallet) and provides a signal only when a negative force is detected or measured at the force sensor (e.g., unloading of the cargo from the pallet). In other words, for a “dead man's switch”-type force sensor, loading the cargo onto the pallet may keep the force sensor in an “off” state whereby no signal is output and unloading the cargo from the pallet causes the force sensor to transition to an “on” state whereby the force sensor provides a signal indicating a force detection or measurement. In some examples, each of multiple force sensors may provide the microcontroller a respective signal. For example, in a cargo tracking device having two force sensors, the force sensors may provide two signals to the microcontroller, one from each of the two force sensors. In some examples, the force sensors may provide the microcontroller a single aggregate signal that aggregates the individual signals from multiple force sensors. In some examples, the aggregate signal may aggregate the respective forces detected at each of the force sensors. For example, in a cargo tracking device that includes three force sensors respectively measuring 5, 10, and 15 kilograms (kg) of force, the aggregate signal provided to the microcontroller may indicate a total of 30 kg of force was measured collectively across the three force sensors. In some examples, the aggregate signal may indicate a quantity of force sensors that have measured some amount of force (e.g., any amount of force and/or a threshold amount of force). For example, in a cargo tracking device having five force sensors with three force sensors measuring a threshold amount of force, one force sensor measuring less than a threshold amount of force, and one force sensor not measuring any force at all, the aggregate signal provided to the microcontroller may indicate a total of three force sensors measured the threshold amount of force. In some examples, a cargo tracking device may include multiple force sensors connected in series and/or in parallel. In some examples, the signal provided to the microcontroller may be a modulated signal and configured to indicate which ones of multiple force sensors detected or measured some amount of positive and/or negative force. In some examples, the modulated signal may indicate which ones of multiple force sensors detected or measured a threshold amount of positive and/or negative force. In some examples, the modulated signal may indicate individual amounts of positive and/or negative force respectively measured by each of multiple force sensors as well as which force sensor corresponds to the amount of force indicated. Stated differently, a cargo tracking device may be configured (e.g., in firmware) with a set force threshold, which may be satisfied based on the magnitude of the detected force and/or a dispersion of the detected force. Satisfying the force threshold may trigger a signal (e.g., a digital “ping”). The force threshold may be satisfied by a range of force values (e.g., 50 pounds of force) or based on multiple sensors detecting respective forces (e.g., a collective amount of force across all sensors or specific sensors). In some examples, the force threshold may be satisfied based on one or more specific sensors detecting respective forces such as one or more sensors designated as “primary” sensors (e.g., a centrally located sensor) and/or one or more sensors designated as “secondary” sensors (e.g., one or more peripherally located sensors). Example force sensors that may be suitable for a cargo tracking device as described herein may include, for example, 1-50 kg (e.g., 1 kg, 5 kg, 10 kg, 20 kg) load cells (e.g., E-shaped load cells) with an HX711 load cell weight sensor/amplifier module, 50-1000 kg (e.g., 50 kg, 100 kg, 250 kg, 500 kg, 1000 kg) button load cells, 100-200 kg (e.g., 100 kg, 200 kg) tension and compression load cells, and the like.

The geolocation module (e.g., geolocation module 312 depicted in FIGS. 3A-3C) may be configured to obtain the geographic location of the pallet and provide the geographic location to the microcontroller. The geolocation module, therefore, may be in signal communication with a satellite positioning system (e.g., a global navigation satellite system, GNSS; a global positioning system, GPS; a quasi-zenith satellite system, QZSS, etc.). The geolocation module may provide the geographic location as a set of geographic coordinates (e.g., latitude and longitude) or other geographic location indicators (e.g. geocodes and the like). In some examples, the geolocation module may be included in an SoC. Example geolocation modules that may be suitable for a cargo tracking device as described herein may include the SparkFun XA1110 GPS Breakout module, the USGlobalSat EM-506N5 GPS receiver, the u-blox SAM-M8Q-0 GNSS patch antenna module, the Adafruit Mini GPS PA1010D Module, and the like In order to reduce costs, sizing, and complexity, in some examples, the geolocation module may include simply a GPS receiver, antenna, and geolocation acquisition chip (e.g., a GNSS chip) with appropriate circuitry. Examples of GPS GNSS receiver chips that may be suitable for a cargo tracking device as described herein may include the STMicroelectronics Automotive universal GNSS RF receiver, the Broadcom BCM4778 L1L5 GNSS receiver, and the like.

The microcontroller (e.g., microcontroller 310 depicted in FIGS. 3A-3C) may be configured to generate the geolocation signal and control its transmission using the one or more communication modules. The microcontroller, therefore, may be in signal communication with the one or more force sensors, the geolocation module, the identification module, and the one or more communication modules. The microcontroller may receive signals from the identification module, the force sensors, and the geolocation module. In some examples, the UID of the cargo tracking device may be embedded in the microcontroller itself (e.g., in firmware) rather than received from the identification module. The geolocation signal generated by the microcontroller may include or otherwise indicate, for example, the UID of the cargo tracking device, the geographic location received from the geolocation module, and the date and time (e.g., as a timestamp) that the force sensors signaled the cargo was unloaded from the pallet. In some examples, the geolocation signal may include other information related to the cargo shipment such as, for example, information about the cargo (e.g., type, owner, manufacturer, seller, buyer, expiration date, and the like), information about the transport (e.g., car, truck, boat, train, plane), information about the transporter (e.g., driver, captain, conductor, pilot), origin of the cargo, destination of the cargo, and the like. The microcontroller also may be configured to encrypt the geolocation signal for authentication. The microcontroller may be configured to employ various techniques to encrypt the geolocation signal including, for example, symmetric keys whereby each cargo tracking devices is associated with symmetric keys that are used to generate a token used to authenticate the geolocation signal, certificates (e.g., X.509 certificates) respectively residing at the cargo tracking device and the system that receives and authenticates the geolocation signal, and/or token-based authentication whereby the cargo tracking devices generates a shared access signature (SAS) token using its symmetric keys that expires after a set duration. The keys and certificates may be embedded, for example, in the firmware of the microcontroller. The microcontroller may be implemented as a single integrated circuit. Example microcontroller units (MCUs) that may be suitable for a cargo tracking device as described herein may depend on the desired form factor of the cargo tracking device (e.g., size) and may include 8-bit, 16-bit, or 32-bit microcontrollers (e.g., a 16 MHz 8-bit MCU available from DigiKey as product number STM8S001J3M3, a medium-density performance line 32-bit MCU available from STMicroelectronics as product number STM32F103C8T6, a 32-bit AURIX™ TriCore™ microcontroller available from Infineon Technologies, and the like).

The microcontroller may be configured to determine the cargo has been loaded and/or unloaded from the pallet based on one or more signals received from one or more force sensors. Loading cargo onto a pallet may be referred to, for convenience, as a loading event. Unloading the cargo from a pallet similarly may be referred to, for convenience, as an unloading event. As described herein, in some examples, the microcontroller may determine the cargo has been unloaded from a pallet based on a single signal received from a single force sensor. In some examples, the microcontroller may determine the cargo has been unloaded from a pallet based on multiple signals respectively received from each of multiple force sensors. In some examples, the microcontroller may determine the cargo has been unloaded from a pallet based on a single signal from multiple force sensors (e.g., an aggregate signal that aggregates the individual signals from multiple force sensors). The microcontroller may include logic (e.g., in software and/or firmware) to process one or more of the signals received. Processing the one or more signals may include, for example, determining a quantity of force sensors that detected or measured a positive or negative force, determining whether a threshold quantity of force sensors measured a positive or negative force, determining which of one or more force sensors detected or measured a positive and/or negative force, determining an amount of positive or negative force measured by a force sensor, determining an aggregate amount of positive or negative force measured by multiple force sensors, determining whether an individual amount of positive or negative force measured by a force sensor satisfies a force threshold, determining whether an aggregate amount of positive or negative force collectively measured by multiple force sensors satisfies a force threshold. For example, a first sensor may detect a first force while a second sensor detects a second force different from the first force, and the aggregate amount of force may be determined based on comparing the first force and second force. The force threshold used by the microcontroller may be fixed at the microcontroller (e.g., in software and/or firmware) or may be a configurable parameter of the microcontroller. Processing the one or more signals also may include determining whether one or more force sensors provided signals indicating force detection or measurement within a specified time duration (e.g., some number of seconds, milliseconds, microseconds, nanoseconds, etc.). For example, the microcontroller may be configured to determine that any signal received from a force sensor within a specified time duration (e.g., within one millisecond) is associated with the same loading or unloading event and that any signal received outside the specified time duration is associated with a different loading or unloading event. In some examples, the microcontroller may be configured to debounce any signals received from the force sensors in order to eliminate noise as a potential false positive and not related to a load or unload event. In some instances, the force threshold may be set high enough in order to eliminate false positives from normal movement during transportation. In other instances, the microcontroller may debounce any signals by determining that a force has been detected or removed for longer than a time threshold. In some examples, the debounce time may be about a half second (0.5 s). In some examples, the microcontroller may be configured to validate any signals received from the force sensors in order to validate load and unload events as true positives. Certain physical movements may result in false positives. Rapidly lowering a pallet (e.g., on a forklift), for example, will reduce the load on a force sensor and may trigger a false positive. Signal validation may facilitate identification of load and unload events as true positives. In some examples, the validation time threshold may be, for example, 30 seconds. The time duration may begin when an initial signal is received from one of the force sensors. The threshold quantity of force sensors may be a discrete quantity (e.g., 3 force sensors) or a percentage of the total force sensors of the cargo tracking device (e.g., 3 of 5 force sensors of the cargo tracking device). The threshold amount of force may include a threshold amount of force measured by any one of multiple force sensors and/or a threshold amount of aggregate force collectively measured by multiple force sensors. For example, a microcontroller may be configured to detect a force loading or unloading event based on (i) a single force sensor individually measuring a threshold amount of force OR (ii) multiple force sensors (e.g., at least 2) collectively measuring a threshold aggregate amount of force.

The microcontroller may be configured to cause transmission of a geolocation signal based on determining that a loading and/or an unloading event has occurred. In response to detecting a loading or unloading event, the microcontroller may generate the geolocation signal as described herein. For example, the microcontroller may obtain (e.g., request, retrieve, access), from the geolocation module, the current measured geographical location as well as the current date and time. The microcontroller also may obtain other information related to the cargo as described herein. The microcontroller may generate the geolocation signal using the obtained information (e.g., geographic location, date, time, etc.). For example, the microcontroller may generate the geolocation signal by appending the geographic location, date, and time. The microcontroller may encrypt or otherwise obfuscate the geolocation signal prior to transmission as described herein. The microcontroller then may provide the geolocation signal to one of the communication modules for transmission.

The one or more communication modules (e.g., communication module 308 depicted in FIGS. 3A-3C) may be configured to wirelessly transmit the geolocation signal generated by the microcontroller. The one or more communication modules can have, by way of example, one or more of a wireless transmitter, a wireless receiver, a wireless transceiver, a modulator, a RF power amplifier, an antenna, etc. The one or more communication modules may be configured to wireless communicate via one or more cellular networks. For example, a communication module may be configured to operate in existing LTE frequency bands in the range of about 600 MHz to about 22 GHz depending on the region and cellular carrier. In some examples, a communication module may be configured for communication via an LTE-M (Long Term Evolution for Machines) cellular network, a 3G cellular network, a 4G cellular network, a 5G cellular network, and the like. In some examples, a communication module may be configured for communication via a non-cellular wireless network, for example, a wireless local area network (WLAN) or a personal area network (PAN). In some examples, a communication module may be configured for wireless communications using one or more of the IEEE 802.11 wireless communication standards (e.g., WiFi). In some examples, a communication module may be configured for wireless communications using other wireless communication standards (e.g., Zigbee, Z-Wave, Bluetooth, Bluetooth Low Energy (BLE), etc.). In some examples, a communication module may be configured for wireless communication via terrestrial radio. In some examples, a paging service such as a Commercial Mobile Radio Service (CMRS) may be used to transmit the geolocation signal indicating a loading or unloading event. As such, the cargo tracking device may be configured to transmit the geolocation signal via one or more channels of the commercial paging frequency bands (e.g., “Lower Band” frequencies such as 35-36 MHZ, 43-44 MHZ, 152-159 MHZ, or 454-460 MHz or “Upper Band” frequencies such as 929 MHz or 931 MHz). In some examples, a wireless communication module may be configured for wireless communication via both cellular and non-cellular networks.

A communication module may include one or more antennas. The type of antenna may vary. In some examples, a communication module may include a printed circuit board (PCB) antenna or a chip antenna. The one or more communication modules may be configured for communication via licensed frequency bands (e.g., 700 MHz band, 800 MHz band, 1.9 GHz band, 1.7 GHz band, 2.1 GHz band, 2.5 GHz band) and unlicensed frequency bands (e.g., 900 MHZ band, 2.4 GHz band, 5 GHz band).

As described herein, the communication modules may receive the geolocation signal from the microcontroller for transmission based on a loading event or an unloading event. As also described herein, a cargo tracking system may receive the transmission and create a record of the loading event or unloading event. In some examples, the tracking system may receive the geolocation signal directly from a communication module of a cargo tracking device. In some examples, a cargo tracking device may not be configured for wireless communication via a cellular network and instead rely on an intermediary wireless device to relay the geolocation signal to the cargo tracking system (e.g., a bridge device). In these examples, a wireless relay device may be located within wireless range of the cargo tracking device and monitor for geolocation signals transmitted by the cargo tracking device (e.g., using WLAN or PAN wireless communication standards). The wireless relay device may be configured for communication via a cellular network and retransmit any received geolocation signals using a cellular network standard (e.g., LTE) for delivery to the cargo tracking system. In some examples, the wireless relay device may be a mobile cellular telephone (smartphone) that monitors (e.g., using an installed mobile application) for any transmitted geolocation signals. The mobile cellular telephone may be, for example, owned and/or operated by an operator (e.g., driver, captain, pilot, conductor) of the transport (e.g., car/truck, boat, plane, train) carrying the cargo. In some examples, the wireless relay device may be a standalone device include with the cargo shipment. Using a wireless relay device may advantageously facilitate transmission of geolocation signals from multiple co-located cargo tracking devices (e.g., in a cargo shipment carrying multiple pallets) using a single cellular communication module. Using a wireless relay device also may facilitate minimizing the overall dimensions and/or footprint of the cargo tracking device and may facilitate minimizing the cost of the cargo tracking device by omitting one electronics component, the cellular communication module, from the cargo tracking device itself.

In some examples, the microcontroller and the one or more communication modules may be packaged together in a single integrated circuit. The integrated circuit may be, for example, a low-power system-on-chip (SoC) such as an Internet-of-Things (IoT) SoC or Bluetooth Low Energy (BLE) SoC. The communication modules may include a multimode LTE-M/NB (narrowband) IoT modem with an integrated radio frequency (RF) front end for communication via cellular networks.

The power supply (e.g., power supply 314 depicted in FIG. 3A-C) may be configured to provide sufficient power for transmitting at least one geolocation signal. In some examples, the power supply may be configured to provide sufficient power for only a single geolocation signal. In other words, in some examples, the power supply may be configured such that transmitting a single geolocation signal depletes the power supply to a point where the cargo tracking device is unable to transmit a subsequent geolocation signal. In some examples, the power supply may be configured to provide sufficient power for multiple geolocation signals (e.g., an initial geolocation signal during a cargo loading event, a final geolocation signal during a cargo unloading event, and/or one or more periodic or intermittent geolocation signals during shipping). In some examples, the power supply may provide sufficient power to the microcontroller for monitoring the status of the one or more force sensors during shipping. In some examples, the microcontroller may be configured to enter a “sleep” state that draws minimal power from the power supply (e.g., sufficient power to monitor for any signal from a force sensor). The microcontroller may be configured to transition from the “sleep” state to an “awake” state based on detecting a signal from a force sensor and transmit the geolocation signal using the power remaining at the power supply as described herein. As also described herein, the power supply may be or otherwise include one or more alkaline batteries to facilitate the disposability of the pad with an embedded cargo tracking device.

The communication links (e.g., communication link(s) 318 depicted in FIGS. 3A-3C) may be configured to send signals to or between one or more housings of a cargo tracker device. In some examples, the signals may be sent to or exchanged between electronic components separately housed in respective housings of a cargo tracking device. In some examples, the signals may be sent from a tethered force sensor to a housing of a cargo tracking device. As described herein, the communication links may connect multiple housings and/or multiple force sensors in a daisy chain-type configuration, a branching configuration, or a web configuration. As also described herein, the communication links also may be configured to mechanically stabilize the orientation of one or more housings of a cargo tracking device. As further described herein, mechanical stabilizers may lack any communication functionality and only provide mechanical stability to the one or more housings of a cargo tracking device. Like the communication links, one or more mechanical stabilizers may connect multiple housings and/or multiple force sensors in a daisy chain-type configuration, a branching configuration, or a web configuration.

Materials that may be suitable for a cargo tracking device as described herein include various types of plastics such as thermoplastics (e.g., Acrylonitrile Butadiene Styrene), polycarbonate, phenyl ether polymers such as polyphenylene oxides (PPOs) and polyphenyl ethers (PPEs), polybutylene terephthalate (PBT), and the like as well as light-weight metals such as aluminum, carbon steel, and stainless steel, and other types of materials such as carbon fiber, and the like. The materials used for the construction of the cargo tracking device (e.g., the housing) may facilitate protecting any housed electronics and facilitate orienting the force sensors of the cargo track in a vertical direction to detect or measure the forces associated with a cargo loading or cargo unloading event. The materials of the cargo tracking device also may be configured to protect the cargo tracking device and its electronic components against solid or liquid foreign objects in various environments (e.g., during manufacturing). For example, a cargo tracking device inserted at or in a corrugated layer during manufacture of the pad may be exposed to heated glue used in the manufacturing process and thus should be protected against permeation of that glue into the housing of the cargo tracking device. The materials, therefore, may be selected based on their ingress protection (IP) ratings. In some examples, materials used to construct the cargo tracking device may have an IP rating of at least IP67, which may be sufficient where the cargo tracking device is not exposed to foreign solids or liquids. For example, a cargo tracking device may be inserted at or in the corrugated layer of the pad after manufacturing the pad or the glue applicator is modified to refrain from applying any glue to the anticipated location of the cargo tracking device at or in the corrugated layer (e.g., a glue-free region at or near the center of the corrugated layer). In some examples, materials used to construct the cargo tracking device may have higher IP ratings (e.g., IP68 or IP69K) where the cargo tracking device is expected to be exposed to foreign solid or liquid objects (e.g., heated glue during pad manufacturing).

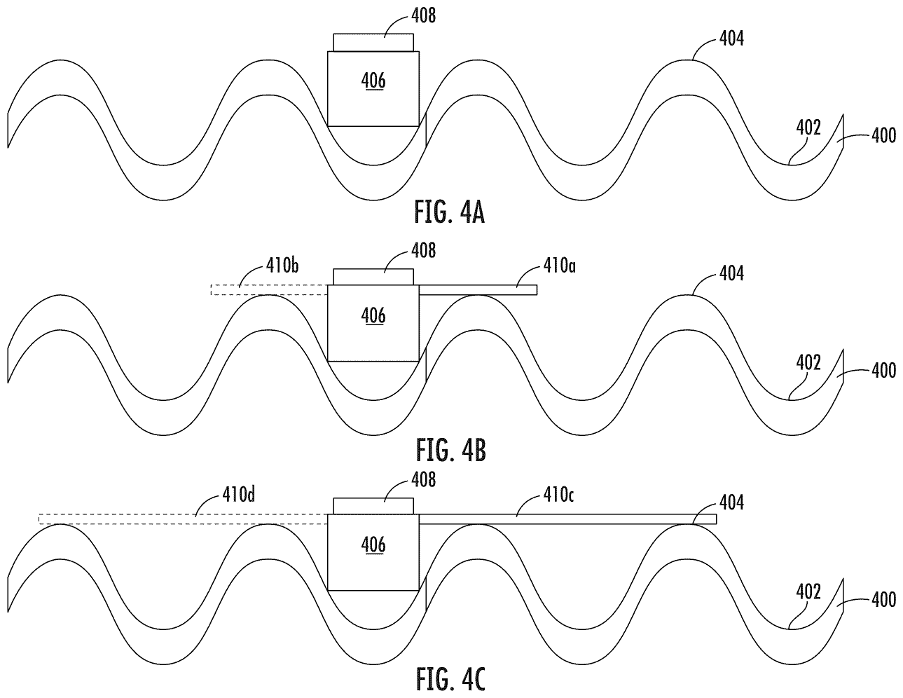

A variety of configurations, arrangements, and constructions may be used for example implementations of a cargo tracking device. Various implementations are depicted by way of example in FIGS. 4A-C, 5A-C, 6A-B, 7A-B, 8A-L, 9A-B, 10A-B, 11-15, 16A-B, 17. As seen in these figures, various permutations and combinations of housings, force sensors, communication links, and mechanical stabilizers are contemplated for the cargo tracking device. Additional and alternative permutations and combinations not explicitly illustrated in the figures are also contemplated and will be appreciated by those of ordinary skill in the art with the benefit of the present disclosures. As seen in the figures and as described herein, example implementations of a cargo tracking device include: a cargo tracking device having a single housing and a single force sensor, a cargo tracking device having a single housing and multiple force sensors, a cargo tracking device having multiple housings and multiple force sensors. As described herein, a housing of a cargo tracking device may reside in a flute of a corrugated layer of the pad. Depending on the width of the flute, the electronics of cargo tracking device may be housed in a single housing having a size that enables it to be at least partially received in a single flute (e.g., a flute having a relatively larger width) or may be housed in multiple housing distributed across one or more flutes (e.g., flutes having relatively smaller widths). In some examples, the electronics of a cargo tracking device may be housed within or otherwise attached to a relatively thin mechanical webbing with the components that reside (at least partially) within the flutes being only mechanical in nature (e.g., to stabilize the webbing containing the electronics on an upper surface of the corrugated layer). In some examples, the cargo tracking device may not include any components, mechanical or otherwise, that are received within any flute of the corrugated layer with the cargo tracking device instead entirely residing on an upper surface of the corrugated pad held in place by the pressure and glue that joins the top layer of the pad to the corrugated layer of the pad.

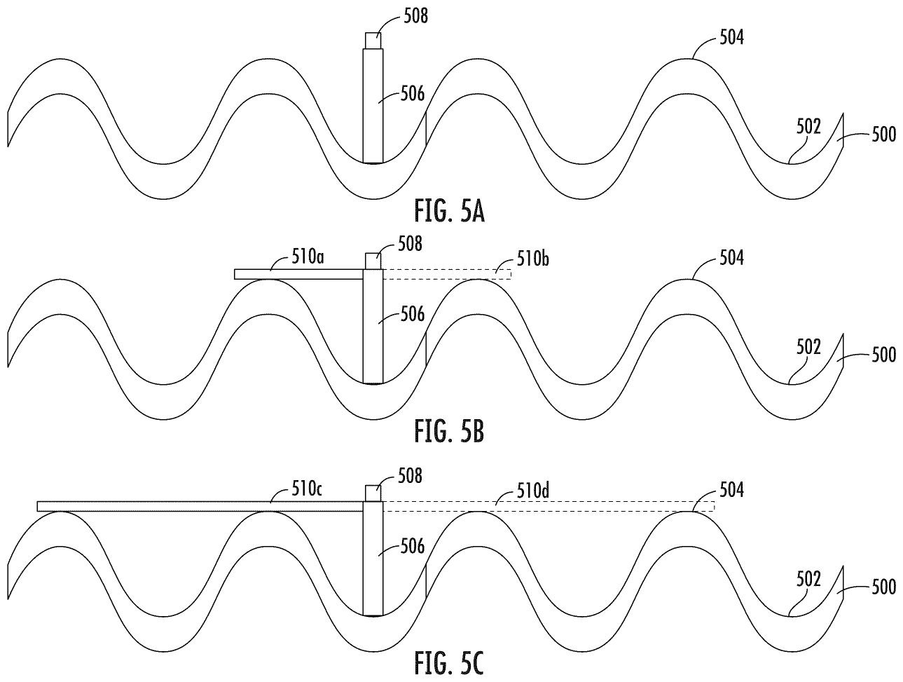

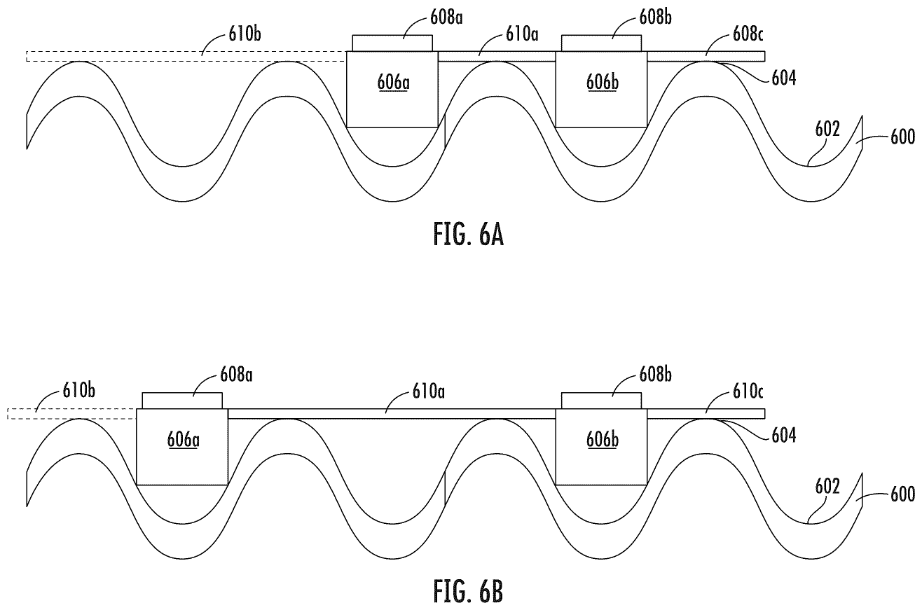

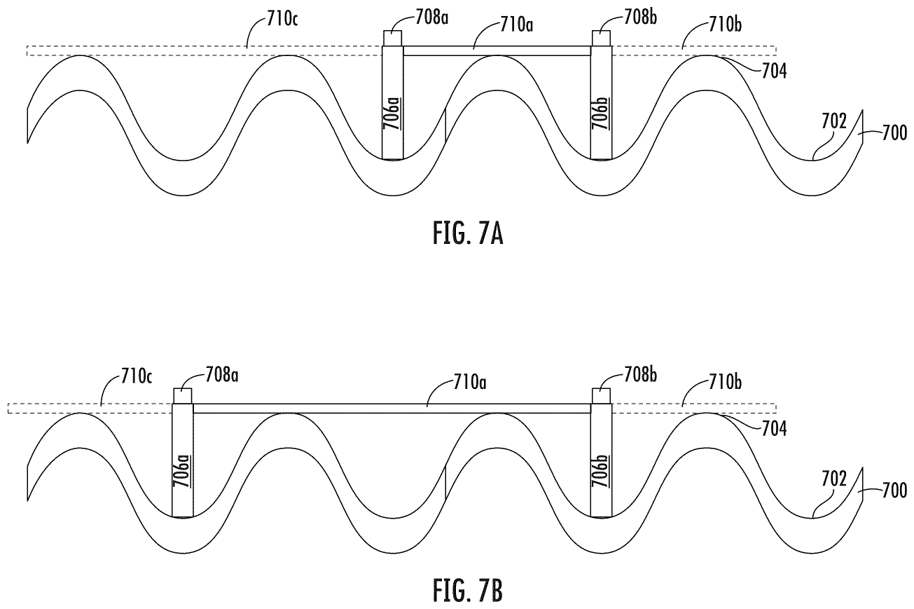

FIGS. 4A-C depict cross-sectional views of a corrugated layer 400 and example implementations of cargo tracking devices having a single, relatively wider housing 406 with a force sensor 408 oriented in a substantially vertical orientation. As seen in FIGS. 4A-C, the relatively wider width of the housing 406 may cause the cargo tracking device to sit relatively higher in the flute 402 but with fewer degrees of freedom to shift back and forth within the flute 402. FIG. 4A depicts an example cargo tracking device that does not include any mechanical stabilizer. FIG. 4B depicts an example cargo tracking device having at least one mechanical stabilizer 410a. The cargo tracking device in FIG. 4B may include a second mechanical stabilizer 410b as indicated by the dashed lines used to depict the second mechanical stabilizer 410b. The mechanical stabilizers 410a and 410 b depicted in FIG. 4B extend between and rest upon adjacent peaks 404 that define the flute 402 containing the cargo tracking device. By resting upon the peaks 404 of the corrugated layer 400, the mechanical stabilizers may resist shifting of the housing 406 in the flute 402. FIG. 4C depicts a similar cargo tracking device as the cargo tracking device of FIG. 4B but with the mechanical stabilizers 410c and 410d extending across an adjacent flute 402 of the corrugated pad 400. The mechanical stabilizers 410c and 410d of the cargo tracking device in FIG. 4C each extend across a single, immediately adjacent flute. In other examples, the mechanical stabilizers may extend across multiple flutes. FIGS. 5A-C depict cross-sectional views of a corrugated layer 400 and example implementations of cargo tracking devices having a single, relatively narrower width compared to the width of the housings in FIGS. 4A-C. As seen in FIGS. 5A-C, the relatively narrows width may cause the cargo tracking device to sit relatively lower in the flute 502 but with more degrees of freedom to shift back and forth within the flute 502. Similar to the cargo tracking devices in FIGS. 4A-C, the cargo tracking devices in FIGS. 5A-C may include one or more mechanical stabilizers 510a, 510b, 510c, and 510d that extend between adjacent peaks 504 of a flute 502 or across multiple flutes. The quantity and length of the mechanical stabilizers, therefore, may depend on the width of the housing 506 of the cargo tracking device. For example, relatively fewer (e.g., zero or one) and/or shorter mechanical stabilizers may be included with cargo tracking devices having relatively wider housings, and relatively more (e.g., two or more) and/or relatively longer mechanical stabilizers may be included with cargo tracking devices having relatively narrower housings. A mechanical stabilizer (e.g. 510c) may extend substantially perpendicularly across one or more flutes, at an oblique angle across one or more flutes, and/or substantially parallel along respective peaks of one or more flutes. In some examples, one or more force sensors 508 (e.g., tethered force sensors) may include one or more mechanical stabilizers (not shown), which may be the same as or similar to the mechanical stabilizers of the housings as described herein. FIGS. 6A-B and 7A-B depict cross-sectional views of a corrugated layer (600 and 700 respectively) and example implementations of cargo tracking devices having multiple housings (606a, 606b, 706a, and 706b respectively). The housings 606a and 606b of the cargo tracking devices in FIGS. 6A-B have a relatively larger width similar to the cargo tracking devices in FIGS. 4A-C, and the housings 706a and 706b of the cargo tracking devices in FIGS. 7A-B have a relatively narrower width similar to the cargo tracking devices of FIGS. 5A-C. In some examples, a cargo tracking device may include one housing have a relatively larger width and another housing having a relatively narrower width. In some examples, the housings of a cargo tracking device may reside in adjacent flutes of the corrugated layer as depicted in FIG. 6A and FIG. 7A. In some examples, the housings of a cargo tracking device may reside in flutes some number of flutes (e.g., one or more flutes) away from the flutes that respectively contain the housings as depicted in FIG. 6B and FIG. 7B. As described herein, a communication link (e.g., 610a or 710a) may connect the respective housings of a cargo tracking device as depicted in FIGS. 6A-B and FIGS. 7A-B. As also described herein, the communication link may also function to provide mechanical stability for the housings. As also seen in FIGS. 6A-B and FIGS. 7A-B, a cargo device having multiple housings also may include one or more mechanical stabilizers (e.g., 610b or 710b) that extend to a peak (604 or 704) defining one of the flutes (602 or 702) of the corrugated layer and/or across one or more flutes of the corrugated layer (600 or 700).

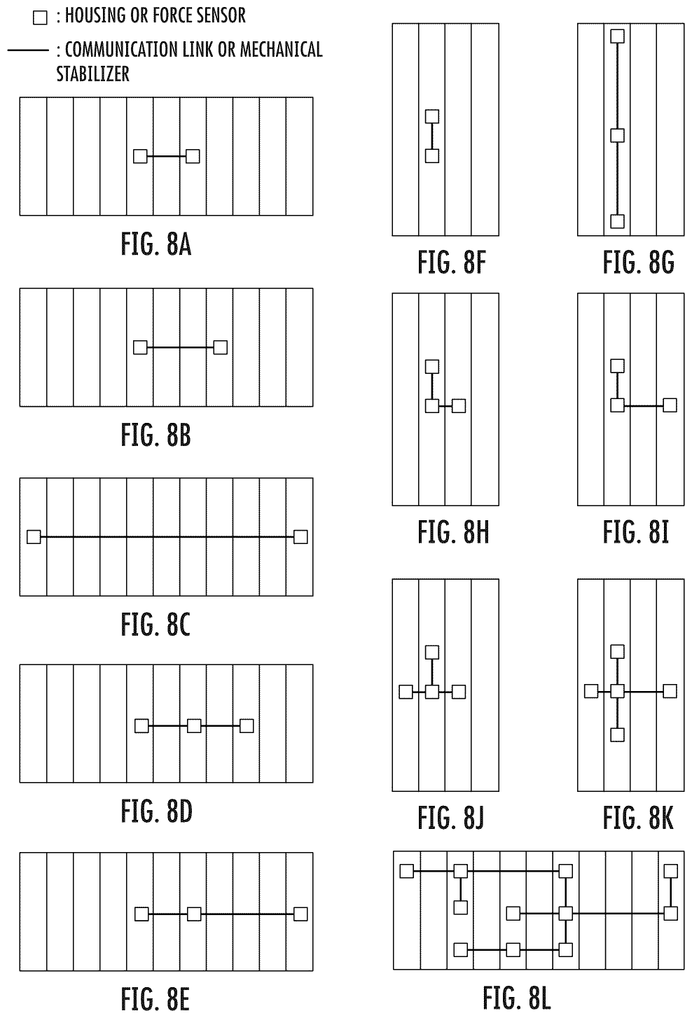

FIGS. 8A-L depict example implementations of cargo tracking devices having multiple housings (806a-1) distributed across one or more flutes (802a-1) with peaks (804a-1) of a corrugated layer (800a-1) of a pad in a variety of arrays. In FIGS. 8A-L, each box-shaped component (806a-1) depicted may be a housing or a force sensors and each line-shaped connector (808a-1) depicted may be a communication link or a mechanical stabilizer. While FIGS. 8A-8L each identify only one corrugated layer (e.g., 800a), flute (e.g., 802a) having a peak (e.g., 804a), housing unit or force sensor (e.g., 806a), and connector (e.g., 808a), not very element is identified and each embodiment may include on ore more of each element. For example, while 802a identifies a flute of the multiple flutes of the corrugated layer 800a, it should be understood that the multiple flutes extend across the corrugated layer 800a separated by the solid lines that represent a peak 804a of each flute. FIG. 8A depicts a cargo tracking device having two components 806a (only one labeled) each respectively residing in individual flutes 802a of the corrugated layer 800a with a connector 808a extending across a single flute. FIG. 8B depicts a similar cargo tracking device as the cargo tracking device of FIG. 8A but with a connector 808b extending across multiple flutes 802b of the corrugated layer 800b (two flutes in this example). FIG. 8C depicts a similar cargo tracking device as the cargo tracking devices of FIGS. 8A and 8B where each component 806c respectively resides in individual flutes 802c at opposite ends of the corrugated layer 800c with a connector 808c extending across the width of the corrugated layer 800c. The flutes containing the respective components in FIG. 8C may be the flutes located at the extreme ends of the corrugated layer (e.g., the flutes respectively located at the right edge and left edge of the corrugated layer). Alternatively, the flutes containing the respective components in FIG. 8C may be flutes located near, but not directly at, the right edge and left edge of the corrugated layer. FIG. 8D depicts a cargo tracking device having three components 806d likewise respectively residing in individual flutes 802d of the corrugated layer 800d with a connector 808d extending across a single flute. FIG. 8E depicts a similar cargo tracking device as the cargo tracking device of FIG. 8D but with one connector 808e extending across a single flute 802e and the other connector 808e extending across multiple flutes of the corrugated layer 800c (three in this example). FIG. 8F depicts a cargo tracking device having two components 806f that both reside in the same flute 802f of the corrugated layer 800f. The footprint of the cargo tracking device in FIG. 8F extends across only a relatively short portion of the flute. FIG. 8G depicts a cargo tracking device having three components 806g that all reside in the same flute 802g of the corrugated layer 800g. The footprint of the cargo tracking device in FIG. 8G extends across substantially the entire length of the flute. FIG. 8H depicts a cargo tracking device having three components 806h with two components residing in the same flute 802h of the corrugated layer 800h and the third component 806h residing in an immediately adjacent flute 802h of the corrugated layer 800h. FIG. 8I depicts a similar cargo tracking device as the cargo tracking device of FIG. 8H but with the third component 806i residing in a flute 802i that is one removed from the flute 802i containing the other two components 806i. FIG. 8J depicts a cargo tracking device having four components 806j with two components 806j residing in the same flute 802j of the corrugated layer 800j, another component 806j (e.g., a third component) residing in one immediately adjacent flute 802j (e.g., a left adjacent flute), and the other component 806j (e.g., a fourth component) residing in the other immediately adjacent flute 802j (e.g., a right adjacent flute). FIG. 8K depicts a cargo tracking device having five components 806k with three components 806k residing in the same flute 802k of the corrugated layer 800k, another component 806k (e.g., a fourth component) residing in a left adjacent flute 802k, and the other component (e.g., a fifth component) residing in a flute 802k one removed from the flute 802k containing the three components 806k. FIG. 8L depicts a cargo tracking device having multiple components 806l distributed in individual flutes 8021 and across multiple flutes 8021 of the corrugated layer 800l (e.g., a network of force sensors spread across multiple flutes). FIG. 8L also depicts a daisy chain configuration and a branching configuration of the components 806l. FIGS. 8A-G illustrate a one-dimensional configuration for the components of a cargo tracking device whereby the housing(s) and/or force sensor(s) extend along a single (one-dimensional) line at the corrugated layer (e.g., along a single flute or across multiple flutes). FIGS. 8H-L illustrate a two-dimensional configuration for the components of a cargo tracking device whereby the housing(s) and/or force sensor(s) extend across a (two-dimensional) plane at the corrugated layer (e.g., along and/or across multiple flutes).

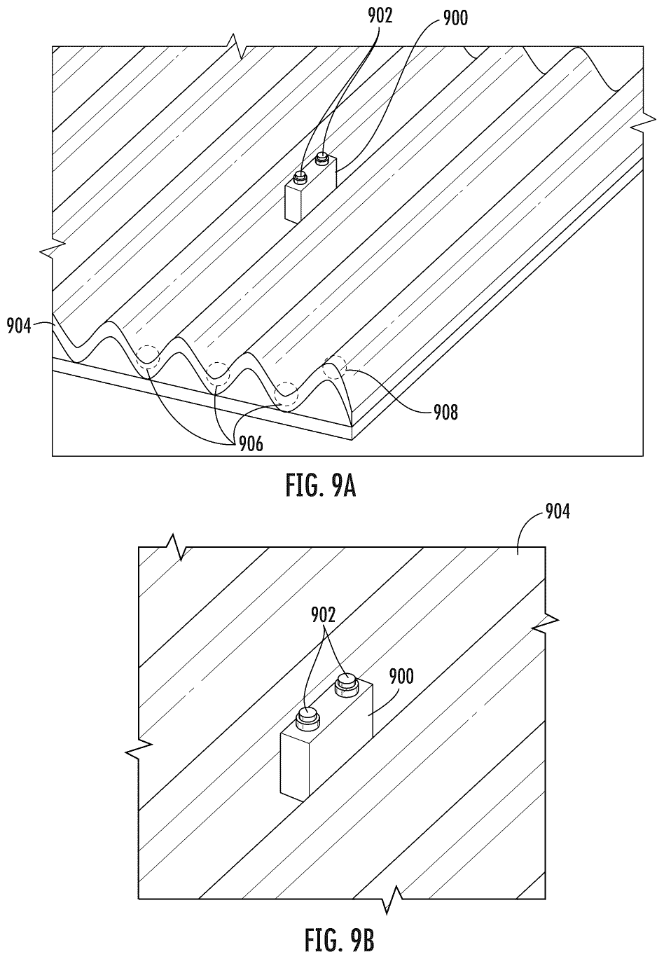

FIGS. 9A-B depict an example implementation of a cargo tracking device having a single housing 900 with two force sensors 902 residing in a single flute 906 of a corrugated layer 904. The housing 900 of the cargo tracking device in FIGS. 9A-B may be constructed of a plastic material. The housing of the cargo tracking device in FIGS. 9A-B has a box-like configuration, which may result in the cargo tracking device shifting back and forth in the flute 906 given the slanted and curved contour of the flute.

FIG. 10A depicts an example implementation of a cargo tracking device having a single housing 1000 with a single force sensor 1002 also residing in a single flute. The housing 1000 of the cargo tracking device in FIG. 10A also has a box-like configuration, which may result in the cargo tracking device shifting back and forth in the flute. FIG. 10B depicts an example implementation of a cargo tracking device having two housing 1010a and 1010b that each include two force sensors 1012a and 1012b and that are connected by a communication link 1016 that extends across multiple flutes of the corrugated layer 1014. The housings 1000, 1010a, and 1010b of the cargo tracking devices in FIGS. 10A-B may be constructed of a metallic material.

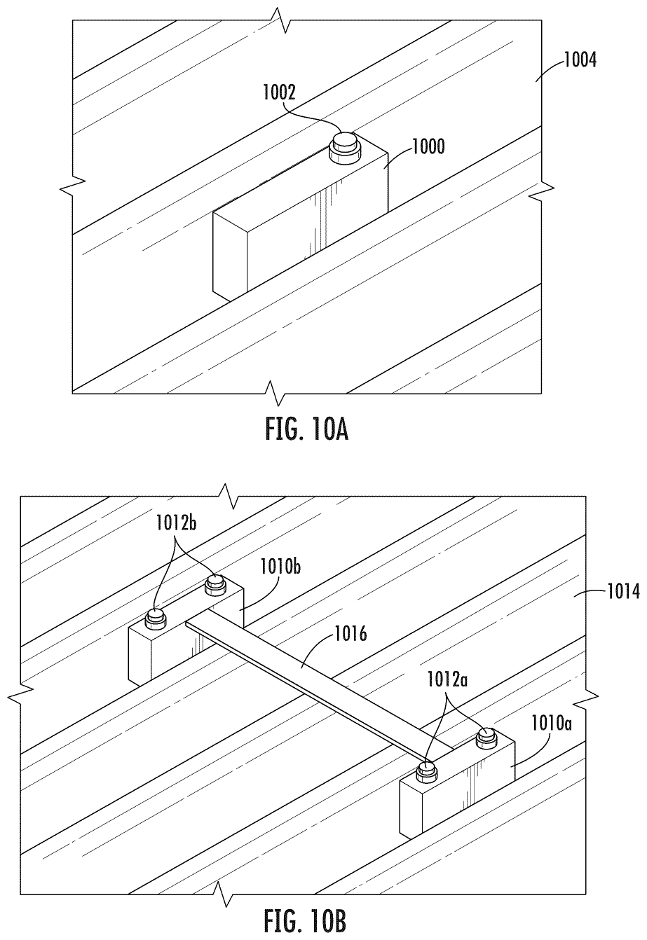

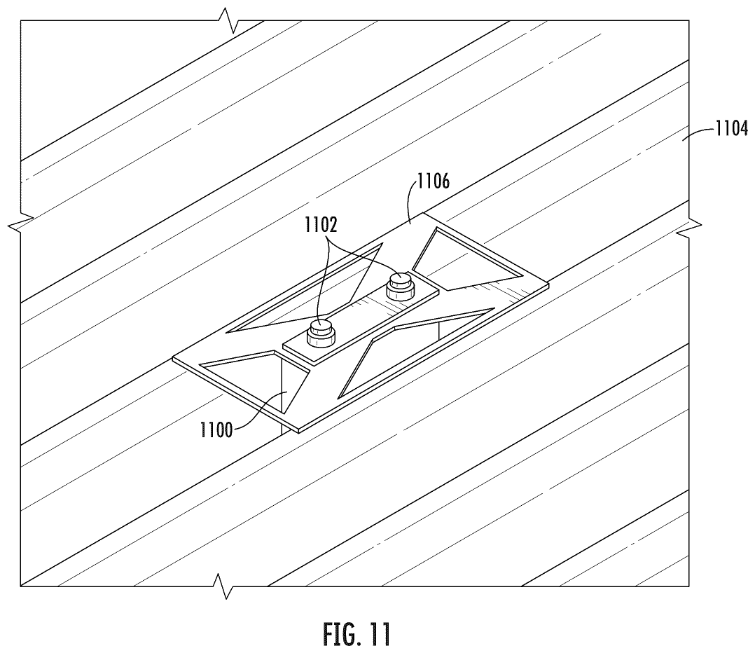

FIG. 11 depicts an example implementation of a cargo tracking device having a single housing 1100 constructed using a metallic material with two force sensors 1102 and a mechanical stabilizer 1106. The mechanical stabilizer 1106 in FIG. 11 has a web-like configuration that includes struts extending substantially perpendicularly between two peaks that define the flute containing the housing 1100 of the cargo tracking device, struts extending along and substantially parallel with the flute peaks, and struts extending at an oblique angle between the housing 1100 and the flute peaks and connected to respective perpendicular and parallel struts. In some examples, a mechanical stabilizer 1106 may span across multiple flutes of the corrugated layer 1104. The mechanical stabilizer 1106 may be constructed using various materials as described herein, for example, plastic materials such as thermoplastics (e.g., ABS), metallic materials, carbon fiber, etc.

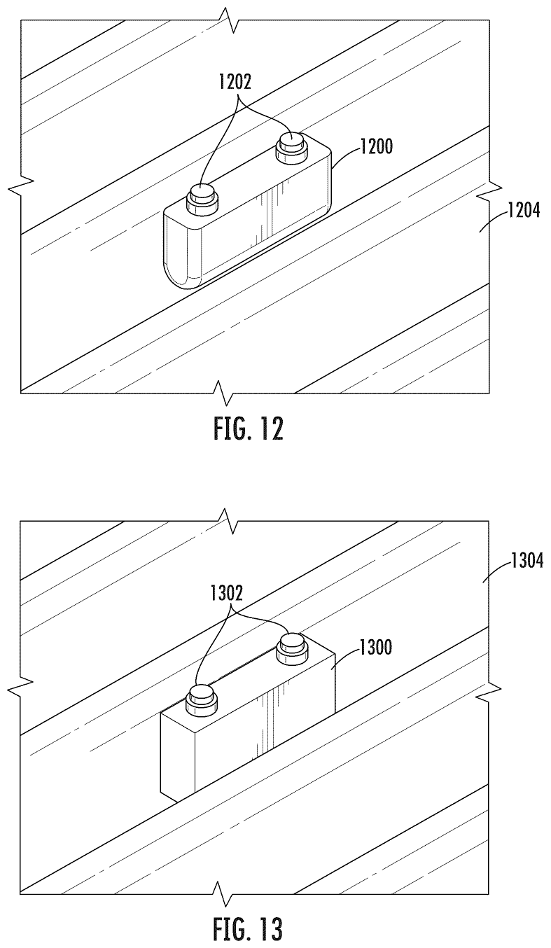

FIGS. 12 and 13 depict different configurations of a housing 1200 and 1300 of a cargo tracking device. The cargo tracking device in FIG. 13, like other examples disclosed herein, includes a housing device 1300 with a box-like configuration, which may result in the housing shifting back and forth in the flute. In other examples, the housing of a cargo tracking device may conform (or substantially conform) to the contour of the flute of the corrugated layer as depicted in FIG. 12 for example. As seen in FIG. 12, the example cargo tracking device includes two force sensors 1202 positioned at a top end of the housing 1200 with a bottom end 1206 of the housing resting within the flute of the corrugated layer 1204. The bottom end 1206 of the housing, in this example, has a curved shape that conforms (or substantially conforms) to the curved shape of the flute. The bottom end 1206 of the housing, in this example, may be described as having a U-shaped (or substantially U-shaped) bottom end 1206. In other words, a cross-section of the housing 1200, in this example, may be described as being U-shaped (or substantially U-shaped). A bottom end (and/or cross-section) 1206 of a housing 1200 of a cargo tracking device may have other shapes that conform (or substantially conform) to the contour of a flute of a corrugated layer 1204, for example, a parabolic (or substantially parabolic) shape, a square (or substantially square) shape, a rectangular (or substantially rectangular) shape, a triangular (or substantially triangular) shape, a trapezoidal (or substantially) shape, and the like. In some examples, a cargo tracking device may include a single housing that spans across and resides within multiple flutes (e.g., two adjacent flutes) having a bottom end that engages with the contour of the corrugated (e.g., the respective contours of the flutes). In some examples, a cargo tracking device may include a single housing that resides within a single flute and a mechanical stabilizer that spans across and engages with the contour of the corrugated layer (e.g., the respective contours of one or more flutes). A bottom end that conforms (or substantially conforms) to the shape of a flute of the corrugated layer may facilitate insertion of a cargo tracking device into a corrugated layer, for example, whereby the conforming bottom end functions to guide the cargo tracking into the flute. A bottom end that conforms (or substantially conforms) to the shape of a flute of the corrugated layer also may facilitate providing mechanical stability to the cargo tracking device when residing within the flute, for example, by limiting the degrees of freedom available for the cargo device to shift back and forth in the flute.

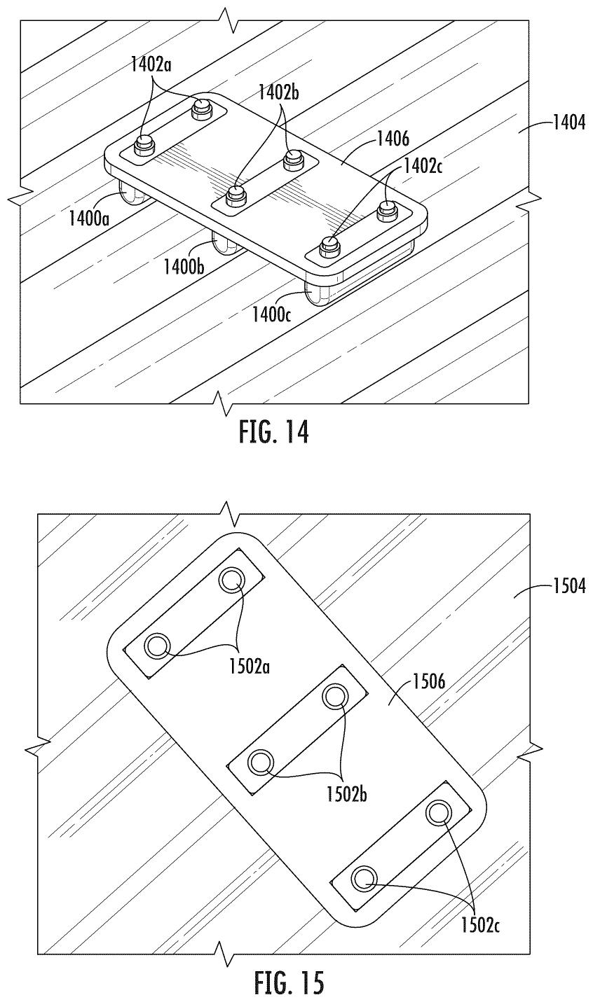

FIG. 14 depicts an example cargo tracking device having multiple features that facilitate providing mechanical stability. The example cargo tracking device in FIG. 14 includes three housings 1400a, 1400b, and 1400c each with two force sensors 1402a, 1402b and 1402c each. A bottom end of each housing, in this example, is U-shaped and conforms to the respective flute of the corrugated layer 1404. The cargo tracking device, in this example, also includes a mechanical stabilizer 1406 in the form of a flat plate (webbing) that extends between and around the three housings 1400a, 1400b, and 1400c of the cargo tracking device. The U-shaped bottom ends and the flat plate, in this example, thus collectively facilitate providing mechanical stability for the cargo tracking device. The flat plate, in this example, includes an overhanging portion that extends beyond the edges of the housings and rests, in at least some locations, on the peaks of the fluted layers. By resting on the peaks of the flutes, the overhanging portion of the flat plate may also facilitate securing the cargo tracking device in place via increased friction between a lower surface of the flat plate and the peaks of the flutes. In some examples, the lower surface of the mechanical stabilizer (e.g., the flat plate) may be textured to increase the friction between the mechanical stabilizer and the corrugated layer. For example, the lower surface of the mechanical stabilizer may include ridges, knurling, or the like to facilitate minimizing sliding or slipping of the cargo tracking device inserted in the corrugated layer. In some examples, the communication links between the housings and/or one or more of the electronic components described herein may be embedded in the flat plate. In some examples, the housings that extend into the flutes of the corrugated layer may be purely mechanical in nature and contain no electronic components with all of the electronic components instead being embedded in the flat plate.

FIG. 15 depicts an example cargo tracking device that is similar to the example cargo tracking device in FIG. 14 but without the housings that extend into the flutes of the corrugated layer. The example cargo tracking device in FIG. 14 similarly includes three pairs of force sensors connected via a flat plate between them. The example cargo tracking device in FIG. 15, however, simply rests on top of the peaks of the flutes of the corrugated layer 1504. All of the electronic components of the cargo tracking device, in this example, may be embedded in the flat plate 1506. The force sensors 1502a, 1502b, and 1502c may be installed (e.g., embedded) directly on the flat plate 1506 itself. Friction between the lower surface of the flat plate 1506 and the peaks of the flutes it rests upon may facilitate securing the cargo tracking device in place. As described herein, a lower surface of the flat plate 1506 may include features that increase the friction between the flat plate and the corrugated layer 1500 (e.g., ridges, knurling, or other types of textured features). As described herein, the cargo tracking device, in this example, also may be secured in place via the top layer of the pad that is applied to the corrugated layer.

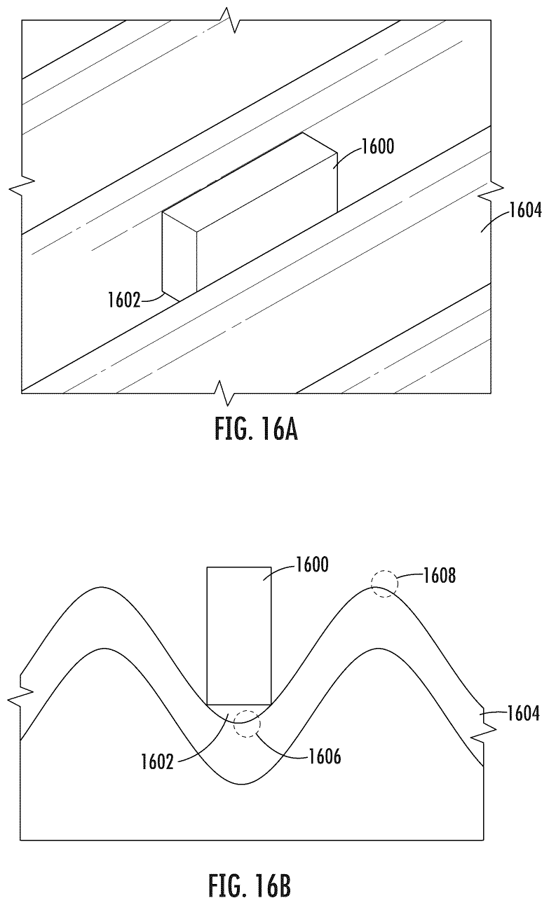

FIG. 16 depicts an example cargo tracking device positioned in an alternative orientation. As seen in prior figures, a cargo tracking device is depicted as being oriented in an upward direction with the force sensors of the cargo tracking device being positioned at or near the peak of the flute of the corrugated layer. In FIG. 16, the example cargo tracking device is depicted as being oriented in a downward direction with the force sensor(s) 1602 of the cargo tracking device being position at or near the valley 1606 of the flute 1608 of the corrugated layer 1604. The “upside down” orientation of the cargo tracking device in FIG. 16 or the “right side up” orientation of the cargo tracking devices in the prior figures may be suitable to detect loading and unloading events so long as it remains in a substantially vertical orientation to detect the force of the cargo being loaded onto or unloaded from the pallet.

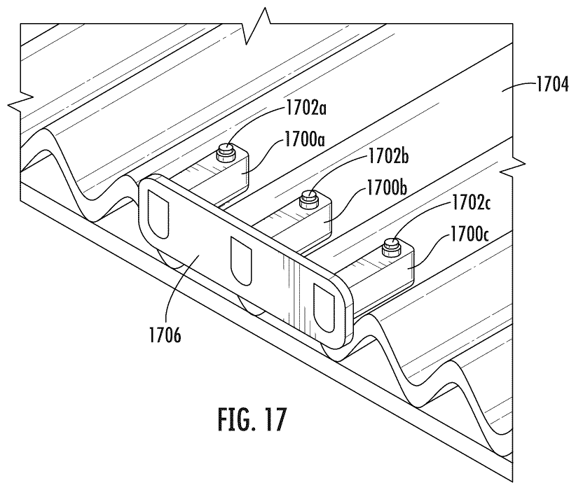

FIG. 17 depicts an example cargo tracking device having an alternative configuration that may facilitate insertion of a cargo tracking device after the pad 1704 has been fully constructed (e.g., with a bottom layer 1703, a corrugated layer 1705, and a top layer). Example cargo tracking devices depicted in prior figures may be inserted into the corrugated layer during manufacture of the pad (e.g., before the top layer is applied to the pad). The example cargo tracking device depicted in FIG. 17, however, may be designed for insertion into a corrugated layer 1705 having a top layer (not shown in FIG. 17) already applied. In some instances, the cargo tracking device may be configured to be integrated into the pad during manufacturing of the pad, whereby the pad and the cargo tracking device are a singular unit once assembled. The cargo tracking device, in this example, includes three housings 1700a, 1700b, and 1700c with one force sensor 1702a, 1702b, and 1702c each. Each of the three housings 1700a, 1700b, and 1700c reside within a respective flute of the corrugated layer 1705. The cargo tracking device, in this example, also includes a flat plate 1706 (webbing) that extends between and around the three housings 1700a, 1700b, and 1700c of the cargo tracking device. The flat plate 1706, in this example, is oriented substantially perpendicular to the layers 1703 and 1705 of the pad 1704 and the housings of the cargo tracking device. The housings 1700a, 1700b, and 1700c thus extend away from the flat plate 1706 into the flutes of the corrugated layer 1705. The flat plate 1706 of the cargo tracking device, in this example, resides outside of the pad 1704 and adjacent to (e.g., in contact with) one or more layers 1703 and 1705 of the pad 1704 (e.g., the corrugated layer). The electronic components of the cargo tracking device may respectively reside in the flat plate 1706 or one of the housings. In some examples, the electronic components may reside entirely in the flat plate 1706 (e.g., with the housings being purely mechanical as described herein), entirely in one of the housings 1700a, 1700b, and 1700c, or be distributed between multiple housings 1700a, 1700b, and 1700c and/or the flat plate 1706. The dimensions of the housings 1700a, 1700b, and 1700c may be configured to secure them within the pad 1704 between the corrugated layer 1705 and the top layer of the pad. For example, the dimensions of the housing 1700a, 1700b, and 1700c may be slightly larger than the dimensions of the flutes of the corrugated layer 1705 in order to be inserted into the corrugated layer 1705 via a press fit and secured via a friction fit between the housings 1700a, 1700b, and 1700c and the flutes and/or top layer of the pad. The outer surface of the housings 1700a, 1700b, and 1700c, in this example, may include features that increase the friction between the housings 1700a, 1700b, and 1700c and the corrugated layer 1705 (e.g., ridges, knurling, or other types of textured features).

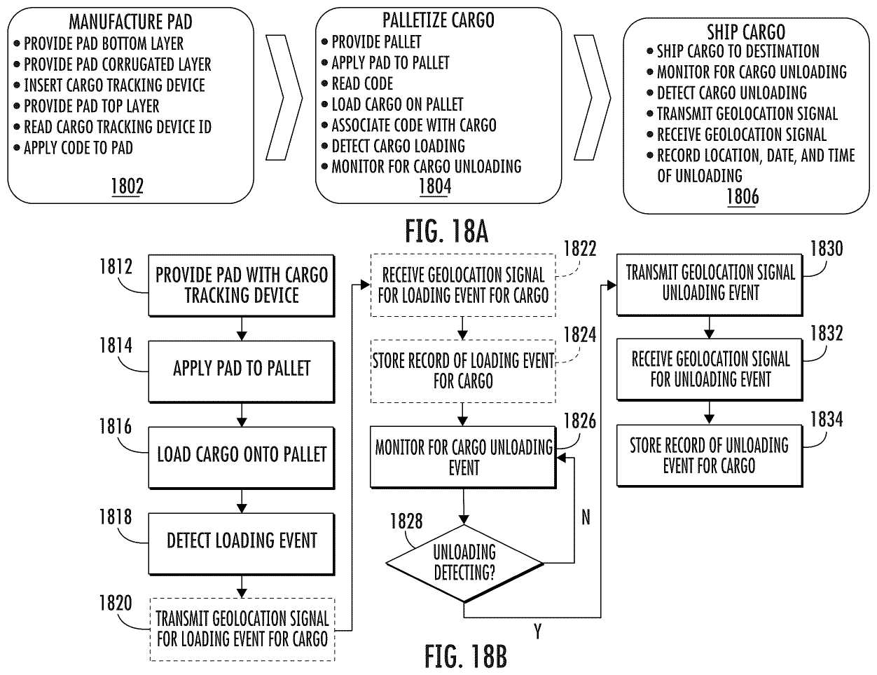

FIG. 18A depicts an example sequence flow for tracking cargo shipments. The sequence flow, in this example, depicts three phases: a pad manufacturing phase 1802, a cargo palletizing phase 1804, and a cargo shipping phase 1806.

During the pad manufacturing phase 1802, the pad with the cargo tracking device is constructed. As described herein, manufacturing a pad may include providing a bottom layer of the pad, providing a corrugated layer of the pad and applying (e.g., gluing) the corrugated layer to the bottom layer, inserting a cargo tracking device into the corrugated layer, providing a pad top layer and applying (e.g., gluing) the pad top layer to the corrugated layer, and laminating the pad. Manufacturing the pad also may include laminating the pad. The UID of the cargo tracking device embedded in the pad may be read and a corresponding code may be applied to the surface of the pad. The code may be, for example, a visual indicator corresponding to the UID read from the cargo tracking device. The visual indicator may be, for example, the UID itself (e.g., alphanumeric text), a barcode (e.g., a one-dimensional bar code such as a Code 39 barcode and the like, a two-dimensional bar code such as a QR Code and the like, etc.), or other type of visual symbol. The visual indicator may, for example, be printed directly on the pad or printed on a label that is applied to the pad. As described herein (e.g., with reference to FIG. 17), a cargo tracking device may be inserted into a pad after manufacturing the pad instead of during pad manufacture. As also described herein, the cargo tracking device may be activated either during or after pad manufacture.

In some examples, the pad may be manufactured using a lithographic lamination process performed by a lithographic laminator. For example, a single-face corrugated base layer having a fluted corrugate upper surface may rise up from a lowered position while a top layer rides down from an upper position and is deposited on the base layer. The laminator may apply appropriate adhesives (e.g., glue) to the corrugated layer that is used to join the upper lay of the pad to the corrugated layer. Before applying the upper layer, a feeder and insertion system, therefore, may be employed to singulate a cargo tracking device (e.g., using a shuttle mechanism) and insert it into the flutes of the corrugated layer before the laminator deposits the top layer. The feeder and insertion system may be configured to monitor the speed and travel distance of the two halves of the laminator to ensure a single cargo tracking device is deposited per pad. For example, the feeder and insertion system may monitor an encoder of a pad manufacturing machine or communicated directly with the pad manufacturing machine and determine when to insert a cargo tracking device based on a signal received from the pad manufacturing machine. In other words, the rate of the feeder and insertion system, may match the rate of the laminator when joining the layers of the corrugated pad. After inserting the cargo tracking device on the corrugated layer, the laminator deposits the top layer on the corrugated layer, and sends the pad through a pressure roller to join the layers of the pad thereby securing the cargo tracking device within the pad. As described herein, the cargo tracking device secured within the manufactured pad may then be activated. For example, the pad manufacturing line may be configured to move the manufactured pads by (e.g., over, under, through, next to) a reader (e.g., scanner) that obtains the UID of the cargo tracking device and then send the manufactured pads to an applicator (e.g., printer) that applies (e.g., as visual indicia) the UID read from the cargo tracking device to the surface of the pad. In some examples, the manufactured pads may be stacked during manufacture, and the pad manufacturing line may be configured to send the stack of manufactured pads to a singulation station that selects (destacks) individual pads from the stack, reads the UID of the cargo tracking device in the selected pad, and applies the visual indicia corresponding to the UID to the surface of the selected pad. In some examples, the pads may be restacked after the visual indicia is applied. For example, the pad manufacturing line may be configured to send the selected pad with the applied visual indicia to a restacking station that restacks the individual pads. In some examples, a handheld scanner and handheld printer (e.g., handheld printer labeler) may be employed to manually read the UID of the cargo tracking device in a pad and apply the visual indicia corresponding to the UID to the surface of the pad. In some examples, the reading and scanning functionality may be combined in a single handheld device.

During the cargo palletizing phase 1804, cargo may be palletized with a pad having an embedded cargo tracking device. For example, a pallet may be provided, a pad with a cargo tracking device may be applied to the pallet, the code applied to the pad may be read (e.g., scanned) and associated with the cargo (e.g., by a cargo tracking system). As described herein, associating the pad with the cargo may include storing a record that associates the UID of the pad with one or more UIDs of the cargo. In some examples, the entire palletized cargo may be identified using a single UID. In some examples, individual elements of the palletized cargo may be associated with respective UIDs. In some examples, respective UIDs may be associated with the entire palletized cargo as well as the individual elements of the cargo. The cargo may be loaded onto the pad, and the cargo tracking device may detect the cargo loading event. In some examples, the cargo loading event may activate the cargo tracking device, which may then begin monitoring for a cargo unloading event. In some examples, the cargo tracking device may be separately activated using a subsequent activation procedure.

Different methods for activating a cargo tracking device may be used. In some examples, the cargo tracking device may be configured to continuously detect any signal from a force sensor (e.g., before, during, and after manufacturing the pad). In these examples, the cargo tracking device may be characterized as “always on” due to its continuous monitoring for a signal from a force sensor. In these examples, a cargo tracking device may be “activated” based on detecting a signal from a force sensor. Given that an “always on” cargo tracking device continuously monitors for a signal from a force sensor, any force threshold set or otherwise configured at the cargo tracking device (e.g., at the microcontroller and/or the force sensor itself) should be set to be greater than the force anticipated during manufacture of the pad (e.g., forces associated with inserting the cargo tracking device at or in the corrugated layer of the pad and securing the cargo tracking device by applying the top layer of the pad to the corrugated layer). In some examples, the cargo tracking device may not detect any signal from a force sensor unless and until it is activated via a defined activation (startup) procedure. In these examples, the cargo tracking device may be characterized as “off” until activated. The cargo tracking device thus may be “off” during manufacture of the pad and then activated once the manufacturing is complete. After the pad has been manufactured with the cargo tracking device secured to or in the corrugated layer, the activation procedure may be used to activate the cargo tracking device. For example, the cargo tracking device may be activated wirelessly after manufacturing the pad using a wireless transmitter installed on the production line (e.g., an RFID wand). Alternative activation procedures may be used to activate a cargo tracking device. Activating the cargo tracking device after manufacturing the pad may facilitate avoidance of false activations when manufacturing the pad. In some examples, activating the cargo tracking device may occur after the cargo has been loaded on to the pallet. For example, an inactive pad may be deposited on a pallet followed by the cargo, and an activation procedure may then be performed to activate the cargo tracking device for the loaded pallet. In some examples, the activation procedure may be automated whereby the loaded cargo passes by a station (e.g., RFID station) that activates the cargo tracking device. In some examples, the activation procedure may be manual whereby the loaded cargo is wanded (e.g., using an RFID wand) to activate the cargo tracking device.

During the shipping phase 1806, the cargo may be shipped to its destination with the cargo tracking device monitoring for an unloading event. Based on detecting an unloading event, the cargo tracking device may generate and transmit a geolocation signal as described herein. The geolocation signal may be received, for example, by a cargo tracking system. Based on receiving the geolocation signal, the location, date, and time of the unloading event may be determined along with the identity of the pad and the identity of the corresponding cargo (e.g., by processing the received geolocation signal and determining the identity of the cargo that is associated with the pad indicated in the geolocation signal). A record may be created and stored for the unloading event as described herein.

FIG. 18B depicts a flowchart of example method steps for cargo tracking. As described herein, a pad having an embedded cargo tracking device may be provided 1812 and applied to a pallet 1814. Cargo may be loaded onto the pallet 1816 with the pad positioned between the cargo and the pallet. The cargo tracking device may detect the loading event 1818. As described herein and as indicated by the dashed lines in FIG. 18B, the cargo tracking device optionally may transmit a geolocation signal for the cargo loading event 1820, and a record of the cargo loading event may be created and stored 1824 based on receiving the geolocation signal 1822. After detecting the cargo loading event, the cargo tracking device may monitor for a cargo unloading event 1826. The cargo tracking device may continue to monitor for the cargo unloading event until it detects unloading of the cargo 1828. Based on detecting the cargo unloading event 1828, the cargo tracking device may transmit a geolocation signal for the cargo unloading event 1830, and a record of the cargo unloading event may be created and stored 1834 based on receiving the geolocation signal 1832. In some examples, the cargo tracking device may transmit respective geolocation signals for both a cargo loading event and a cargo unloading event. In some examples, the cargo tracking device may transmit a geolocation signal only for a cargo loading event. In some examples, the cargo tracking device may transmit a geolocation signal only for a cargo unloading event.

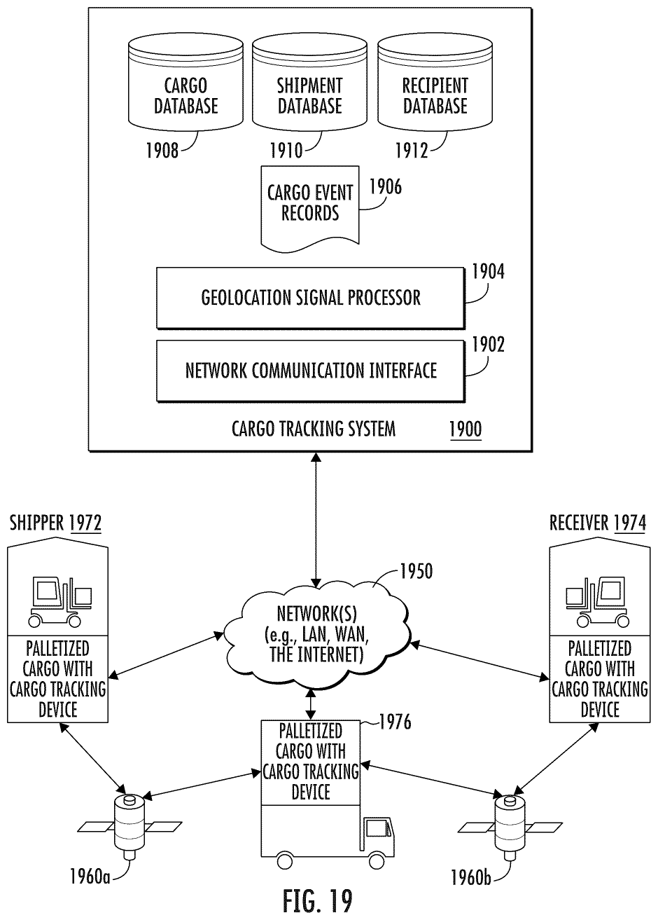

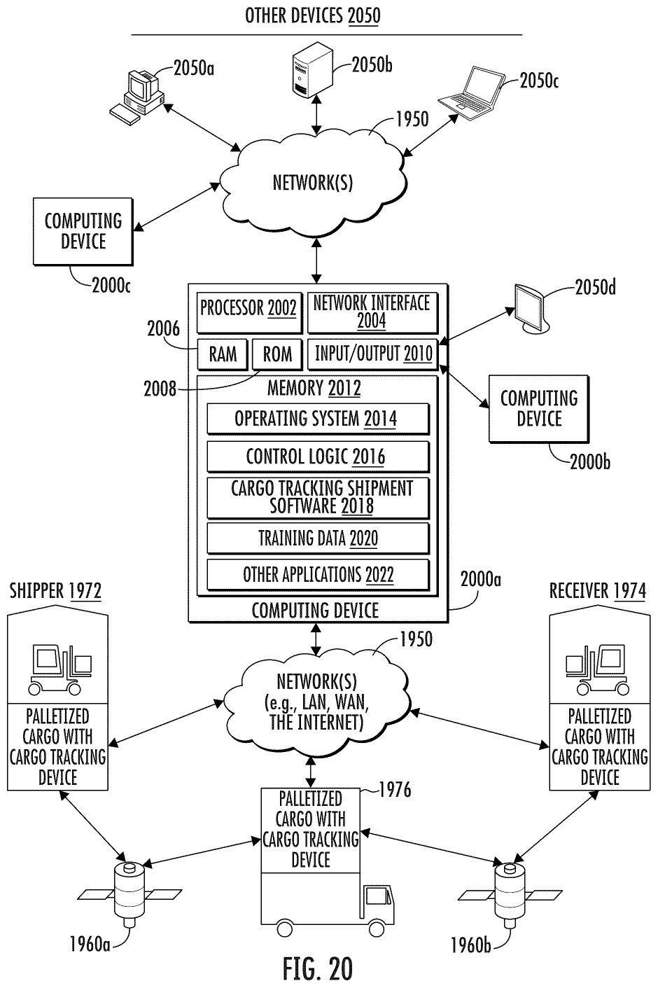

FIG. 19 depicts a block diagram of an example cargo tracking system 1900. In some examples, the cargo tracking system 1900 may be owned and/or operated by the shipper 1972 of the cargo. In some examples, the cargo tracking system may be owned by a third-party that provides the shipper of the cargo with access to the cargo tracking system. In some examples, the receiver 1974 of the cargo also may have access to the cargo tracking system. The shipper 1972 of the cargo and/or the receiver 1974 of the cargo, therefore, may be in signal communication with the cargo tracking system via one or more networks 1950 (e.g., one or more local area networks (LANs), one or more wide area networks (WANs) such as the Internet, one or more cellular networks, one or more satellite networks, and the like). A cargo tracking system may include one or more databases (e.g., cargo database 1908, shipment database 1910, and recipient database 1912) for storing information associated with the cargo (type, quantity, manufacture date, expiration date, and the like), the cargo shipments (e.g., the shipper, shipment date, bills of lading, and the like), and the recipients of the cargo shipments (e.g., the receiver, address, and the like). The shipment database 1910 also may associate a particular pad with a cargo shipment (e.g., via a relationship between a pad record and a cargo record, via a pairing of the UID of the cargo tracking with the UID(s) of the cargo). The information associated with the cargo, shipments, and recipients may be stored in a single database (e.g., relational database) or distributed across multiple databases. The cargo tracking system, in this example, includes a cargo database 1908, a shipment database 1910, and a recipient database 1912. The cargo tracking system, in this example, also includes a network communication interface 1902, a geolocation signal processor 1904, and a set of cargo loading-unloading records 1906. The network communication interface 1902 may be configured to receive the geolocation signals transmitted by the cargo tracking devices based on detecting cargo loading events and/or cargo unloading events as described herein. In some examples, the communication interface 1902 may be or otherwise include a web server and/or a base station. In some examples, a shipper 1972 or receiver 1974 may install a base station at their respective facilities that functions as a bridge device to monitor for geolocation signals and relay any detected geolocation signals to the cargo tracking system (e.g., via a network such as the Internet). The network communication interface 1902 of the cargo tracking system may be in signal communication with the geolocation signal processor 1904. The geolocation signal processor 1904 may be configured to process the geolocation signals received via the network communication interface 1902 and create corresponding cargo event records. For example, the geolocation signal processor 1904 may be configured to extract, from the geolocation signal, the UID of the cargo tracking device, the geographic location, the date, and the time. As described herein, processing the geolocation signal may include decrypting and/or authenticating the geolocation signal. The geolocation signal processor 1904, in this example, also may be configured to determine the cargo associated with the extracted UID of the cargo tracking device. The geolocation signal processor 1904, therefore, also may be in signal communication with one or more of the cargo database 1908, the shipment database 1910, and/or the recipient database 1912 (e.g., in order to perform queries and/or lookups of records associated with the cargo tracking device, cargo, shipment, etc.). The geolocation signal processor 1904 also may be configured to generate and store a record corresponding to the cargo event based on the geolocation signal received. The cargo event records may include, for example, records of cargo loading events and/or cargo unloading events. In some examples, the records of the cargo events may be stored in a database (e.g., a relational database). In some examples, the records of the cargo events may be stored in an immutable data store such as a distributed ledger (e.g., a blockchain). Storing cargo events (e.g., loading, unloading) in immutable records such as a blockchain may facilitate shippers and receivers fulfill certain regulatory requirements (e.g., food handling and safety requirements). In some examples, the cargo tracking device 1900 may intermittently or periodically transmit geolocation signals to the cargo tracking system during shipment.

A cargo tracking system as described herein may include one or more application servers for receiving and processing messages transmitted by cargo tracking devices. One or more application servers may be configured to perform track-and-trace operations and thus include track-and-trace control logic. A cargo tracking system thus may be configured to perform operations similar to those described in commonly-owned U.S. Provisional Patent Application No. 63/590,911 titled “Tracking Seal Device, System and Method,” U.S. Provisional Patent Application No. 63/564,945 titled “Tracking Device, System and Method,” and U.S. patent application Ser. No. 18/915,817 titled “Sealing Device, System, and Methods” filed in Oct. 15, 2024, each of which is incorporated by reference herein in its entirety.

For example, one or more application server may be implemented as a cloud-based IoT hub. In addition to track-and-trace control logic, an application server may include one or more data stores that store data associated with the cargo tracking devices, products transported on pallets with the cargo tracking devices, and shipments of the products. Such data may include cargo tracking device data, product data, and shipment data. This data may be stored in a single data store or separate data stores. For example, one or more relational databases may be used to store the cargo tracking device data, product data, and shipment data with tables and records corresponding to the cargo tracking devices, products, and shipments and with relationships between those records conveying associations between cargo tracking devices, products, and shipments. For example, cargo tracking device records may include the unique device IDs of cargo tracking devices and may be related to shipment records to indicate a cargo tracking device included with a pallet being transported for the shipment. Shipment records may be related to one or more product records to indicate the products being shipped on the pallet tracked by one of the cargo tracking devices. In some examples, a shipment may include multiple pallets each with an individual cargo tracking device. As such, a shipment record also may be related to one or more cargo tracking device records. Product records may be related to other product records to indicate products that are combined in a combination product (e.g., a variety pack, a multi-pack) or products that are ingredients of another product. Product records may also include KDEs (key data elements) for CTEs (critical tracking events) associated with the product including, for example, TLCs (traceability lot codes) associated with the products. In some examples, CTEs may be stored as separate CTE records that are related to the product records and that include the KDEs for the CTEs.

The track-and-trace control logic may be implemented as one or more software applications and/or services executed by the one or more application servers. The track-and-trace control logic in configured to implement the track-and-trace operations of the cargo tracking system. The track-and-trace operations include, for example, receiving and processing messages received from or triggered by the cargo tracking devices (e.g., initial geolocation messages when loading shipments onto the pallets with the cargo tracking devices, intermittent geolocation messages sent during transit, and final geolocation messages sent when removing shipments from the pallets with the cargo tracking devices), storing records of tracking events (e.g., on a distributed ledger), analyzing reported geolocations (e.g., to provide notifications and alerts), and provisioning cargo tracking devices prior to installing them at pallets for shipment.

The track-and-trace control logic may be configured to perform multiple operations to process a message received from the cargo tracking devices. For example, the track-and-trace control logic may be configured to decrypt and authenticate the message (e.g., using symmetric keys, tokens, or certificates). The track-and-trace control logic also may be configured to extract the information included in the message such as, for example, the device ID of the cargo tracking device, the current geolocation, and the current date and time. Extracted information also may include any additional information included in the message such as, for example, information about the contents of the shipment, about the transport, and/or about the shipment as described herein. In some examples, the track-and-trace control logic may be configured to perform a query or lookup of the product information, transport information, and/or shipment information using the device ID included in the message. For example, the track-and-trace control logic may be configured to query the data store containing the cargo tracking device data to obtain the corresponding record for the cargo tracking device as well as any related product records or shipment records included in the data stores storing the product data and the shipment data.

The track-and-trace control logic also may be configured to generate and store records corresponding to messages that memorializes the transition of cargo tracking devices between their unloaded and loaded states as well as the status updates received during transit. The track-and-trace control logic may be configured to store the records as traceability records on a distributed ledger. The distributed ledger may be a public or private distributed ledger. The distributed ledger may be implemented, for example, as a blockchain (e.g., the Ethereum blockchain). The traceability records may include information identifying the cargo tracking device that caused (e.g., sent, triggered) the message, information identifying the products shipped on the pallet and any associated KDEs, information about the shipment and any associated CTEs, and the like. As described above, track-and-trace control logic may obtain the information included in the traceability records from the information sent in the message from the cargo tracking devices and/or from the data stores storing the cargo tracking device data, the product data, or the shipment data (e.g., based on a query or lookup of the data stores). As noted above, storing the traceability records on a distributed ledger such as a public blockchain provides an immutable history of CTEs (e.g., shipping events, receiving events) that enables reliable and accurate reporting on the shipping, receiving, and transformation of products that move through the supply chain. To ensure privacy, the information included in the traceability records stored on the distributed ledger may be encrypted. In some examples, the traceability records may have a unique record ID (e.g., a smart contract ID), and the track-and-trace control logic may save the record ID in a data store at the one or more application servers. In some examples, a new traceability record may be created for individual CTEs along the supply chain. In some examples, a single traceability record may be created for a product that may be updated upon each CTE that occurs as the product moves through the supply chain.

Storing traceability records may be helpful to comply with food safety regulations that impose requirements on entities along the food and beverage supply chain. For example, the Food Safety Modernization Act aims to shift the focus from responding to foodborne illness to preventing it. New food traceability rules are expected to require that entities along the food and beverage supply chain maintain records containing KDEs associated with specific CTEs in order to provide information to the regulatory entities such as the United States Food and Drug Administration (“FDA”) within some reasonable time (e.g., within 24 hours). For example, food traceability rules may impose traceability recordkeeping requirements for entities that manufacture, process, pack, transport, or holds food and beverages including any listed on a food transport list (“FTL”). CTEs may include, for example, harvesting, cooling, initial packing, first land-based receipt, shipping, receiving, and transformation. KDEs may include, for example, a unique TLC, the quantity and unit of measure for the food or beverage, a description of the food or beverage, a description of the location of an immediately subsequent receiver of the food or beverage, a description of the location of an immediately preceding shipper of the food or beverage, the shipment date, a reference to or a description of the location of the source of the TLC. Food traceability rules are expected to require KDEs to be linked to the food or beverage product at each CTE. Furthermore, TLCs may be required for certain types of CTEs such as, for example, packing a raw agricultural commodity, receiving food from a fishing vessel during a first land-based receipt, and transforming a food. Food traceability rules also may require that traceability records for each CTE include the relevant TLC assigned to the food or beverage product. The disclosures herein of maintaining records based on messages sent from low-cost, disposable cargo tracking devices with tracking and tracing capabilities further address these needs of fulfilling regulatory requirements related to traceability recordkeeping and providing timely reports on the shipping, receiving, and transformation of products moving through the supply chain. As one example, when a food, beverage, or ingredient is indicated as compromised, individual products containing that ingredient may be promptly identified and tracked via the TLC assigned to those products and the corresponding traceability records maintained for the CTEs associated with those products.

The cargo tracking systems described herein also provide improvements over traditional recordkeeping for products moving through the supply chain. As described herein, a distributed ledger is used to store traceability records, which immutably logs CTEs and associated KDEs in a manner that ensures its privacy, security, accuracy, validity, and reliability. This immutability of the traceability records thus gives confidence to regulatory entities such as the FDA in the validity of the information contained those records. Using a distributed ledger to store CTEs and KDEs in immutable traceability records also provides safeguards against data manipulation or alteration by bad actors.

The cargo tracking systems described herein further provide improvements to traceability records for products that are combined into a collective whole. As one example, products with individually assigned TLCs may be transformed by packaging or repackaging them into a variety pack or multi-pack. As another example, commodities sourced from different suppliers (e.g., fruits, vegetables, fish, meat, and the like) may be assigned individual TLCs before being combined into a new product during a transformation process along the supply chain. The cargo tracking systems described herein are configured to combine TLCs associated with products combined during a transformation process that allows tracking and tracing CTEs and KDEs for both the combined result and its individual subcomponents.

The track-and-trace control logic also may be configured to generate notifications and alerts based on messages received from the cargo tracking device. For example, the track-and-trace control logic may be configured to generate and send an alert based on a mismatch between the current geolocation indicated in a message received at an application server and an expected geolocation of the product. The track-and-trace control logic may be configured to determine whether a current geolocation matches an expected geolocation, for example, by determining a distance between the two geolocations and comparing the distance to a threshold distance. If the current geolocation is within the threshold distance of the expected geolocation (e.g., within x feet or meters), then the track-and-trace control logic may determine the current geolocation matches the expected geolocation; otherwise the track-and-trace control logic may determine the current geolocation does not match the expected geolocation. The track-and-trace control logic may determine the distance between the two geolocations, for example, by determining a distance between respective pairs of latitude and longitude coordinates or by resolving the two geolocations to an address and determining the distance between the addresses. In this way, the track-and-trace control logic may generate and send an alert if a cargo tracking device detects an unloading event at a location other than its intended destination. The track-and-trace control logic also may be configured to generate an alert if the current geolocation deviates from an expected route for the shipment. For example, the shipment data may indicate a route for the shipment between a shipper and a receiver. The track-and-trace control logic may be configured to compare the current geolocation of a message received by an application server while the shipment is in transit and compare that geolocation to locations on the expected route as described herein. The track-and-trace control logic also may be configured to generate and send notifications to indicate that a shipment has left the shipper's premises and/or has been successfully received at a receiver's premises. Notifications and alerts may be sent using any suitable communication means including, for example, electronic mail, text message, popup dialogs, and the like.

The cargo tracking system may provide a dashboard that one or more client computing device may use to invoke the track-and-trace functions. The computing devices may include one or more of a web browser or a mobile application used to access the dashboard (e.g., over the Internet or via a LAN). In some examples, a computing device may include either or both of the web browser or mobile application used to access the dashboard. The dashboard may be configured to provide access to the track-and-trace functionality performed by the track-and-trace control logic. The dashboard may be configured to provide, for example, reporting functions to generate various types of reports such as, for example, inventory reports, daily production reports, inbound shipment reports, outbound shipment reports, product recall reports, product hold reports, and the like. The dashboard may be configured to define parameters for automatic reports generated on a regular basis (e.g., daily, weekly, monthly). The dashboard also may be configured to provide, for example, search functions to search for information related to cargo tracking devices, products, and shipments. The dashboard may be configured to search based on TLC, cargo tracking device ID, variety pack or multi-pack lot number, raw material, work order, purchase order, fulfillment status, and the like. The dashboard may be configured to filter search results based on product information and/or shipment information, for example, based on origination location (e.g., source location, manufacture location, transformation location), destination location (e.g., receiver location), expiration date, status, customer, and the like. The dashboard may be configured to allow selection of products and/or shipments to recall or hold. The dashboard may be configured to display product information including, for example, shipping progress (e.g., a progress bar indicating a series of shippers and receivers along the supply chain), entities that have handle the product as it moves through the supply chain, geolocations of messages sent by a cargo tracking device included with a palletized shipment for transit through the supply chain (e.g., a visual map indicating the geolocations of all messages sent by a cargo tracking device), recall status or hold status, and the like. The dashboard also may provide the traceability record IDs associated with a cargo tracking device, product, and/or shipment and provide links to the traceability records stored at the distributed ledger. The dashboard may navigate to a traceability record based on receiving user input that selects the link associated with the traceability record. The track-and-trace control logic also may provide a ticketing service (not shown) to submit support tickets requesting assistance with issues or problems related to a product or shipment. The dashboard also may be configured to receive user input associated with message sent from an application server to the cargo tracking devices. For example, the dashboard may be configured to receive user input that causes an application server to select a cargo tracking device and send a message (e.g., a “wake up” message) to the selected cargo tracking device. In some examples, an application server may be configured to intermittently (e.g., periodically) send messages (e.g., “wake up” messages) automatically to one or more cargo tracking devices. The dashboard may be configured to receive user input that configures the frequency at which the messages are sent to one or more selected cargo tracking devices (e.g., daily, weekly, monthly, or every x time period). In some examples, an application server may be configured to send a message (e.g., a “wake up” message) to a cargo tracking device automatically based on not receiving any status message from the cargo tracking device after a pre-defined or manually defined duration. The dashboard, for example, may be configured to receive user input indicating the duration that must elapse before the application server sends the message to one or more selected cargo tracking devices. Additional and alternative track-and-trace functionality exposed by the dashboard will be appreciated with the benefit of this disclosure.

The track-and-trace control logic also may be configured to provision cargo tracking devices before installing them at a pallet. Provisioning the cargo tracking devices may include, for example, assigning a unique device ID to the cargo tracking device. Provisioning the cargo tracking devices also may include installing the symmetric keys and/or certificates used for encrypting and authenticating the messages from the cargo tracking devices. Provisioning the cargo tracking devices further may include writing product data and/or shipment data to the memory of the cargo tracking devices for inclusion in the messages sent from the cargo tracking devices. A computing device may be configured to connect to the cargo tracking devices in order to provision them with information received from an application server.

The disclosure is operational with numerous other general purpose or special purpose computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

In FIG. 20, a block diagram of an example of a computing device 2000a that may be used in implementing one or more aspects described herein is shown. For example, a computing device may, in some examples, implement one or more aspects of the disclosure by reading and/or executing instructions and performing one or more actions based on the instructions. The computing device may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

The computing device 2000a may, in some examples, operate in a standalone environment. In other examples, the computing device 2000a may operate in a networked environment. As seen in FIG. 20, various nodes may be interconnected via a network 1950, such as the Internet. Other networks may additionally or alternatively be used, including private intranets, corporate networks, LANs, wireless networks, personal networks (PAN), etc. The network shown in FIG. 20 is for illustration purposes and may be replaced with fewer or additional computer networks. A LAN may have one or more of any known LAN topology and may use one or more of a variety of different protocols, such as Ethernet. The devices shown in FIG. 20 and other devices (not shown) may be connected to one or more of the networks via twisted pair wires, coaxial cable, fiber optics, radio waves or other communication media.

As seen in FIG. 20, the computing device 2000a may include a processor 2002, RAM 2006, ROM 2008, network interface 2004, input/output interfaces 2010 (e.g., keyboard, mouse, display, printer, etc.), and memory 2012. The processor 2002 may include one or more computer processing units (CPUs), graphical processing units (GPUs), and/or other processing units such as a processor adapted to perform computations associated with tracking cargo shipments and/or analyzing records of cargo shipments using an iterative methodology and/or forms of machine learning. The I/O 2010 may include a variety of interface units and drives for reading, writing, displaying, and/or printing data or files. The I/O 2010 may be coupled with a display and/or with another computing device 2000b. The memory 2012 may store software for configuring the computing device into a special purpose computing device in order to perform one or more of the various functions discussed herein. The memory 2012 may store operating system software 2014 for controlling overall operation of the computing device, control logic 2016 for instructing computing device to perform aspects discussed herein, cargo shipment tracking software configured to perform any of the processes and/or methods described above, training data 2020 that is usable to train any or all of the machine-learning models configured for modeling cargo shipments, and other applications 2022. The control logic 2016 may be incorporated in and may be a part of the cargo shipment tracking software. In other examples, the computing device may include two or more of any and/or all of these components (e.g., two or more processors, two or more memories, etc.) and/or other components and/or subsystems not illustrated here.

The other devices and/or systems shown in FIG. 20 may have similar or different architecture as described with respect to the computing device. Those of skill in the art will appreciate that the functionality of the computing device (or other computing devices) as described herein may be spread across multiple data processing devices, for example, to distribute processing load across multiple computers, to segregate transactions based on expected parallel processing efficiencies, geographic location, user access level, quality of service (QOS), to use cloud-based computing services, etc. For example, multiple computing devices may operate in concert to provide parallel computing features in support of the operation of the control logic, cargo shipment tracking software, and/or the other applications.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer-executable instructions may be stored on a computer readable medium such as a hard disk, optical disk, removable storage media, solid state memory, RAM, etc. The functionality of the program modules may be combined or distributed as desired in various embodiments. The functionality also may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

The articles “a” and “an” are used herein to refer to one or to more than one (i.e., to at least one) of the grammatical object of the article. By way of example, “an element” means one element or more than one element. Furthermore, “about” as used herein when referring to a measurable value such as an amount, a temporal duration, and the like, is meant to encompass variations of ±20%, ±10%, ±5%, ±1%, and ±0.1% from the specified value, as such variations are appropriate according to the understanding of one of ordinary skill in the art. Ranges: throughout this disclosure, various aspects of the invention can be presented in a range format. It should be understood that any description in describing a range is provided for convenience and brevity and should not be construed as an inflexible limitation. Where appropriate according to the understanding of one or ordinary skill in the art, the description of a range should be considered to have specifically disclosed all the possible subranges as well as individual numerical values within that range. For example, description of a range such as from 1 to 6 (1-6) should be considered to have specifically disclosed subranges such as from 1 to 3 (1-3), from 1 to 4 (1-4), from 1 to 5 (1-5), from 2 to 4 (2-4), from 2 to 6 (2-6), from 3 to 6 (3-6), etc., as well as individual numbers within that range, for example, 1, 2, 2.7, 3.0, 3.25, 4, 4.675, 5, 5.03, and 6.00 with an appropriate quantity of significant digits according to the understanding of one or ordinary skill in the art. This applies regardless of the breadth of the range.

Although the subject matter has been described in language specific to structural features and/or methodological acts, it is to be understood that the subject matter defined in any statement of example embodiments is not necessarily limited to the specific features or acts described above. Furthermore, the operations described herein may be conditional. For example, various operations may be performed if certain criteria are met. If the one or more criteria are met, various examples may be used. It may be possible to implement any portion of the examples described herein in any order and based on any condition.

While aspects of the present disclosure have been described in terms of preferred examples, and it will be understood that the disclosure is not limited thereto since modifications may be made to those skilled in the art, particularly in light of the foregoing teachings. For example, although various examples are described herein, features and/or steps of those examples may be combined, divided, omitted, rearranged, revised, and/or augmented in any desired manner. Various alterations, modifications, and improvements will be appreciated by those skilled in the art and are intended to be part of this description, even if not expressly stated herein, and are intended to be within the spirit and scope of the disclosures herein. The disclosures herein, therefore, are by way of example only, and are not limiting. For example, features of the examples described above may be combined with features of the examples described in Appendix A and Appendix B (filed with the parent application to which the present application claims the benefit of, i.e., U.S. Provisional Patent Application No. 63/670,196 incorporated by reference herein) and illustrated in their respective figures. In particular and without limitation, the features directed to the cargo tracking device and/or cargo tracking system described above may be applied to, combined with, or otherwise implemented using the features directed to the hardware design, electronics design, firmware, software, mobile app, web/cloud services, communication stack, data handling, security, user interface, design concepts, options, use cases, and the like as described in Appendix A and Appendix B filed with that provisional patent application. Furthermore, it will be appreciated that the disclosures provided herein may be implemented in additional and alternative contexts beyond palletized shipments. For example, the disclosures provided herein may be implemented in the context of other types of shipping materials, e.g., disposable or reusable containers (e.g., boxes whereby a cargo tracking devices is installed (e.g., deployed, placed, positioned, integrated) at (e.g., on, in) an internal surface (e.g., bottom surface) of a container, support structure, or other shipping material to detect loading and unloading events when cargo or other items are placed into, placed onto, and removed from such containers, support structures, or other materials in a manner that creates opportunities to detect loading and unloading events. In this regard, cargo tracking devices as described herein may be installed at any surface or support structure to detect loading and unloading events. More generally, the disclosures provided herein may be employed in additional and alternative contexts beyond shipments themselves and may be implemented in any context where there is a preference or need for detecting a loading or unloading event on a tracking device and providing a geolocation in response.

What is claimed is:

1. A cargo tracking device comprising:
at least one force sensor;
a housing comprising a processor communicatively coupled to the at least one force sensor, wherein the housing is configured to at least partially reside within at least one flute of a corrugated material and configured to position the at least one force sensor to detect a change in force at an upper side of the corrugated material; and
a wireless transmitter;
wherein the processor is configured to, based on the at least one force sensor detecting the change of force at the upper side of the corrugated material, cause, via the wireless transmitter, wireless transmission of information indicating:
an identifier of the cargo tracking device;
a current geographic location of the cargo tracking device; and
a current date and time.

2. The cargo tracking device of claim 1, wherein the housing further comprises the at least one force sensor.

3. The cargo tracking device of claim 1, further comprising:
one or more extensions connected to the at least one force sensor, wherein the one or more extensions are configured to resist a change to an orientation of the at least one force sensor relative to the upper side of the corrugated material.

4. The cargo tracking device of claim 1, further comprising:
a second housing unit, communicatively coupled to the housing, comprising the wireless transmitter.

5. The cargo tracking device of claim 1, further comprising:
a second force sensor communicatively coupled to the processor.

6. The cargo tracking device of claim 5, further comprising:
a connector coupled to and extending from the at least one force sensor and the second force sensor, wherein the connector is sufficiently rigid to resist a change to an orientation of the at least one force sensor and the second force sensor relative to the upper side of the corrugated material.

7. The cargo tracking device of claim 1, wherein the at least one force sensor is configured to extend above the at least one flute of the corrugated material.

8. The cargo tracking device of claim 1, further comprising an array of force sensors that comprises the at least one force sensor, wherein the array of force sensors is distributed across the upper side of the corrugated material.

9. The cargo tracking device of claim 8, wherein array is configured to position a first force sensor and a second force sensor along a common flute of the corrugated material.

10. The cargo tracking device of claim 8, wherein the array is configured to position a first force sensor at a first flute of the corrugated material and a second sensor at a second flute of the corrugated material that is different from the first flute.

11. The cargo tracking device of claim 1, wherein the housing comprises a first portion having a shape that substantially conforms to a shape of the at least one flute of the corrugated material.

12. The cargo tracking device of claim 1, wherein the processor is configured to detect a loading event based on a threshold amount of force applied to the at least one force sensor.

13. The cargo tracking device of claim 1, wherein the processor is configured to detect an unloading event based on a threshold amount of force removed from the at least one force sensor.

14. The cargo tracking device of claim 1, wherein the processor is configured to obtain the current geographic location of the device based on detecting a threshold change in an amount of force at the at least one force sensor.

15. The cargo tracking device of claim 1, wherein the processor is configured to detect a loading event and unloading event based on a threshold quantity of the at least one force sensor indicating a threshold change in an amount of force at respective force sensors of the at least one force sensor.

16. A method comprising:
installing, at a cargo transportation surface, a tracking device, wherein the tracking device comprises at least one force sensor, a processor, and a wireless transmitter;
detecting, based on a force being received by the at least one force sensor, a loading event;
detecting, based on the force being removed from the at least one force sensor, an unloading event; and
sending, via a wireless transmission and based on the unloading event, a message comprising a current geographic location of the tracking device.

17. The method of claim 16, wherein detecting the loading event is based on the force received by the at least one force sensor satisfying a first force threshold; and
wherein detecting the unloading event is based on the force being removed from the at least one force sensor satisfying a second force threshold.

18. The method of claim 16, wherein detecting the unloading event comprises the force being removed from the at least one force sensor for longer than a time threshold.

19. The method of claim 16, wherein determining a loading event further comprises:
receiving, by a first force sensor of the at least one force sensor, a first signal;
receiving, by a second force sensor of the at least one force sensor, a second signal;
comparing, by the processor, the first signal and the second signal; and
detecting, based on the comparing the first signal and the second signal, a loading event.

20. The method of claim 16, wherein installing the tracking device positions the tracking device at an orientation sufficient to detect a change in force at an upper side of the cargo transportation surface.

21. The method of claim 16, further comprising encrypting the message.

22. A system comprising:
a tracking device comprising:
at least one force sensor;
a housing comprising a processor communicatively coupled to the at least one force sensor wherein the housing is configured to at least partially reside within at least one flute of a cargo transportation surface and configured to position the at least one force sensor to detect a change in force at an upper side of the cargo transportation surface;
wherein the processor is configured to detect, based on a force being received by the at least one force sensor, a loading event;
wherein the processor is configured to detect, based on the force being removed from the at least one force sensor, an unloading event; and
wherein the processor is configured to, based on the unloading event, cause, via a wireless transmitter, wireless transmission of information indicating:
an identifier of the tracking device;
a current geographic location of the tracking device; and
a current date and time; and
a server configured to receive the wireless transmission from the processor, wherein the server stores the information of the wireless transmission.

23. The system of claim 22, wherein the tracking device further comprises:
a plurality of force sensors electronically coupled to each other;
at least one extension, connected to the plurality of force sensors, wherein the extension sufficiently rigid to resist a change to an orientation of the plurality of force sensors relative to the upper side of the cargo transportation surface;
a GPS unit configured to obtain, based on the processor detecting an unloading event, the current geographic location of the tracking device;
wherein the housing comprises a first portion having a shape that substantially conforms to a shape of the at least one flute of the cargo transportation surface;
wherein the processor is configured to detect a loading event based on a threshold amount of force being applied to the plurality of force sensors; and
wherein the processor is configured to detect an unloading event based on a threshold amount of force being removed from the plurality of force sensors.

24. The system of claim 22, wherein the tracking device is integrated into the cargo transportation surface.

25. The system of claim 24, wherein the tracking device is integrated between a top layer and a bottom layer of the cargo transportation surface.

26. The system of claim 24, wherein the cargo transportation surface is a corrugated pad.
